(19) United States
(12) Patent Application Publication
(10) Pub. No.: US 2019/0075783 A1
(43) Pub. Date: Mar. 14, 2019

(54) COMPONENT

(71) Applicant: Jürgen BUCHSTALLER, Nürnberg (DE)

(72) Inventor: Jürgen BUCHSTALLER, Nürnberg (DE)

(21) Appl. No.: 16/082,896

(22) PCT Filed: Mar. 8, 2017
(86) PCT No.: PCT/EP2017/055485

§ 371 Date: Sep. 6, 2018

(30) Foreign Application Priority Data
Mar. 9, 2016 (DE) 10 2016 104 325.7

(51) Int. Cl. A01M 25/00; A01M 23/08

(52) U.S. Cl. CPC A01M 25/004; A01M 23/08

(57) ABSTRACT

The disclosure relates to a Component of (for forming) a movable or immovable object, comprising:
a Component Body;
at least one holding device for holding a bait for pests, which holding device is comprised of a housing which delimits at least one receptacle chamber for receiving at least one bait, wherein the housing is comprised of at least one platform which delimits at least one pass-through opening through which a pest can gain access to a bait arranged in said housing;
   wherein at least a part of the holding device, in particular at least one part of the housing, and/or at least one part of the at least one platform, and/or at least one part of an accommodation device which device delimits an accommodation space for accommodating the holding device, is physically integrated with at least one portion of the Component Body.

### CROSS-REFERENCE TO RELATED APPLICATIONS

This application is a U.S. national stage entry of International Application. PCT/EP2017/055485 filed Mar. 8, 2017 under 35 U.S.C. § 371, which claims priority to German Patent Application serial no. 102016104325.7 filed Mar. 9, 2016. The contents of these applications are incorporated herein by reference in their entirety.

The invention relates to a component, particularly for serving as a component of (for forming) a movable or immovable object.

Components for forming movable or immovable objects, which comprise, e.g., structures (i.e. objects in the subject area of structural engineering) or parts thereof, are basically known in the art. The functional and structural characteristics of individual components of a given object are selected depending on the nature of the object.

It is known that certain movable objects, such as containers, and certain immovable objects, such as structures, may be disposed in regions which are or may become infested by pests (e.g. rodents, such mice or rats, etc., or insects, such as maggots or cockroaches, etc.).

To defend against various pests, baits are commonly used, which in particular may be comprised of baits which are comprised of poisons or of ingredients which bring about the death of the pests and/or prevent them from reproducing. Typically, the baits used for pest control are held in special bait-holding devices.

To provide an object such as a building or structure with pest control means, special bait-holding devices must be installed on or in the components of which the object is comprised, in a series of suitable installation steps. This process is costly in terms of expense, labor, and time, and thus is a fitting subject for improvement. The process is also attended by certain risks in the technical aspects of occupational safety and health.

The object of the invention is to devise a component of the general type described above, which is improved over known components.

This object is achieved in particular by a component (hereinafter “Component”) according to the claims. The dependent claims relate to particular embodiments of the described Components.

The Component described herein is used in general for forming or fabricating a movable or immovable object. Thus the described Component may comprise a part of a movable or immovable object. It is self-evident that the Component may itself comprise a movable or immovable object.

The term “movable object” may be understood to mean, e.g., a technical component part or module (comprising a plurality of component parts) which is removably connected to a support and/or is movable relative to a support, i.e. in general is not permanently fixed to a support; wherewith if removable the movable object may be removable (detachable) without attendant damage or destruction. A movable object may be provided for an outer region or an inner (interior) region. The term “immovable object” may be understood to mean, e.g., a structure or a part thereof which is not removably connected to a structure [(as defined above)], and/or is not movable relative to a support, i.e. in general is permanently (and firmly) fixed to a support. An immovable object may be provided for an outer region or an inner (interior) region.

An example of a movable object is a movably mounted container, which may be movable by suitable means, e.g. wheels, rollers, or rail-like means, and is intended to contain, e.g., wastes, materials which are to be spread [over a ground surface], etc.; another example of a movable object is a vehicle or other means of transport, e.g. a railroad train or a ship. Accordingly, a Component in the present context may comprise a container, or a component for forming a container, or an element of a vehicle or other means of transport. The preceding list of possible “movable objects” is not exhaustive.

An example of an immovable object is a structure [(as defined above)]. A “structure” in the present context may comprise a structural object associated with an above-ground [and/]or below-ground structure. Examples of such “structures” are, e.g., boundary structures (e.g. in the nature of boundary walls or fences), bridges, frames, scaffolding, channels (especially in a system for disposal of sewerage and/or wastewater and/or runoff water), conduits, shafts, and manholes (especially conduits or shafts or manholes in a system for disposal of sewerage and/or wastewater and/or runoff water), masonry, poles, piles, posts, columns, pylons, support means, staircases, tunnels, towers, supply panels [(e.g. for utilities such as electricity, gas, and water)], walls, etc. Accordingly a “Component” may be in the form of, e.g., an element of an abovementioned structure, e.g. a boundary element for delimiting a certain area or three-dimensional space; a bridge element for forming a bridge; a frame element or scaffolding element for forming a frame or scaffold; a channel element for forming a channel (especially a channel in a system for disposal of sewerage and/or wastewater and/or runoff water); a shaft element or conduit element or manhole element (especially such an element in a system for disposal of sewerage and/or wastewater and/or runoff water) for forming a shaft or conduit or manhole; a tunnel element for forming a tunnel; a masonry element (particularly a brick or stone) for forming a masonry structure; an element relating to and employed for forming a pole, pile, post, column, pylon, tower, or castle; a step element or staircase element for forming a staircase; a wall element (particularly a prefabricated structural element) for forming a wall of a structure (particularly a building); or a support element for supporting another structure (which may comprise e.g. a seat structure, such as a park bench). The preceding list of possible “immovable objects” is not exhaustive.

The functional and structural characteristics of individual components (“Components”) of a given object are selected depending on the nature of the object.

The Component may be equipped with suitable connecting elements, which are designed to cooperate with corresponding partner connecting elements associated with another component (or “Component”) which is engaged by forcible engagement (e.g. frictional) and/or by form-interlocking engagement, whereby the components are connected by a connection employing forcible (e.g. frictional) and/or form-interlocking engagement means. Suitable connecting elements may comprise threaded elements, or form-interlocking elements such as, e.g., projections, recesses, and undercut configurations.

Depending on the functional and structural characteristics of the Component, the Component may be comprised of, e.g., metal, ceramic, or plastic. In the case of a Component intended for a “structure” or a part of a “structure”, the Component may be comprised of a material of construction which is curable and/or pourable, e.g. concrete, or of a plastic which in particular may be extrudable or injection-moldable, e.g. a polyolefin, e.g. PA, PC, PE, PP, or PS, and may be thermoplastic. Self-evidently, the Component may be comprised of various parts or sections which may have different compositions. As an example, the Component may comprise a channel element, shaft element, conduit element, or manhole element, for a channel structure, shaft structure, conduit structure, or manhole structure, and may be comprised of a material of construction which is (optionally) curable and/or pourable, e.g. concrete, or of a plastic which in particular may be extrudable or injection-moldable, e.g. a polyolefin, e.g. PA, PC, PE, PP, or PS, and may be thermoplastic.

The Component is comprised of at least one component body (hereinafter, “Component Body”). The term “Component Body” can be understood to mean a part of the Component which (essentially or substantially) determines the geometric shape, in particular the basic geometric shape, of the Component.

The Component further is comprised of at least one device for holding a bait (hereinafter, “the holding device”) (cf. “accommodation device”). The holding device is comprised of a housing. The housing delimits a “receptacle chamber” for receiving at least one bait. The housing comprises at least one platform, which may be designated as or may be deemed to be a bait platform. The platform may be disposed in, or formed in, the housing. The platform delimits a pass-through opening (not described in detail) through which a pest can access a bait arranged in the housing. The pass-through opening thus defines an upper region (of the housing) above said pass-through opening, and a lower region (of the housing) below said pass-through opening. The bait is typically disposed in the upper region [(of the housing)]. Thus, the upper region forms a “receptacle chamber” delimited by the housing or by elements of the housing. The bait (or one of the baits) may be disposed directly on the platform, or on a special bait-holding device. Such a bait-holding device typically is also disposed in the upper region [(of the housing)].

At least one part of the so-called “holding device”, in particular at least one part of the housing and/or at least one part of at least one platform disposed or formed in the housing, is formed by at least one portion of the Component Body. In other words, at least one part of the holding device, in particular at least one part of the housing and/or at least one part of at least one platform disposed or formed in the housing, is integral to and (and/or) of unit construction with at least one portion of the Component Body. Thus, the holding device is completely or at least partially integrated into the Component Body. This is achieved in that a wall region of the Component Body also forms a wall region of at least one wall of the holding device; in particular it forms a wall region of at least one wall of the housing which is associated with the holding device. Thus, the holding device is integrally incorporated in, integrally attached to, or integrally connected to the Component Body, over a particular region of said Component Body. In this regard, the holding device, at least in some regions, is comprised of the same material as the Component Body, wherewith in particular the connection between the holding device and the Component Body may be accomplished by means of direct bonding of the same or similar materials.

A particularly advantageous embodiment of the Component is as a channel element, shaft element, conduit element, or manhole element, to be employed as a part of a channel structure, shaft structure, conduit structure, or manhole structure which forms (or forms part of) a system for disposal of sewerage and/or wastewater and/or runoff water. The Component and the functional components associated therewith, i.e. the holding device and/or an accommodation device described in more detail below, thus comprise an integral part of the above-described channel element, shaft element, conduit element, or manhole element, so that a system comprised of the said elements is provided with pest control means by the installation of at least one suitable Component. Thereby special installation steps for installing (individual) bait-holding devices are rendered unnecessary. Self-evidently, this benefit is obtained with all embodiments of the Component.

Alternatively to or in addition to the at least partial integration of a part of the holding device into a region of the Component Body, at least part of an accommodation device for accommodating the holding device may be formed at least in portions by at least one region or portion of the Component Body. In other words, at least part of the accommodation device may be structurally integral to or of unit construction with at least one region or portion of the Component Body. Thus, the accommodation device is completely or at least partially integrated into the Component Body. This is achieved in that a wall region of the Component Body also forms a wall region of a wall of the accommodation device. Thus, the accommodation device is integrally incorporated in, integrally attached to, or integrally connected to the Component Body, over a particular region of said Component Body. In this regard, the accommodation device, at least in some regions, is comprised of the same material as the Component Body, wherewith in particular the connection between the accommodation device and the Component Body may be accomplished by means of direct bonding of the same or similar materials.

The geometric shape of the structure of the Component may basically be chosen over a broad range, i.e. is somewhat arbitrary. Regarding the integration of the holding device and/or the accommodation device into the Component Body, at least with respect to some portions of the latter, various options are available, as follows: The holding device and/or the accommodation device may be integrated into the Component Body, either completely or in some portions [of the holding device and/or the accommodation device]. If the holding device and/or the accommodation device is/are structurally integrated into the Component Body in some portions [of said holding device and/or said accommodation device], it/they [(said holding device and/or said accommodation device)] may extend outside of the Component Body, whereby they will at least to some extent have an effect on (or determine or form) the outer geometric shape of the Component. If the holding device and/or the accommodation device is/are structurally integrated into the Component Body in some portions [of said holding device and/or said accommodation device], it/they [(said holding device and/or said accommodation device)] may extend outside of the Component Body, whereby they will at least to some extent have an effect on (or determine or form) the outer geometric shape of the Component.

Thus it is basically possible that the at least one part of the holding device and/or of the accommodation device which is comprised of at least one portion of the Component Body is comprised completely or at least partially of a wall of the Component Body. Alternatively, the at least one part of the holding device and/or of the accommodation device which is comprised of at least one portion of the Component Body may be integrated completely, or at least partially, into a wall of the Component Body.

For the example in which the Component Body, at least in some regions, in particular completely, has a (hollow) cylindrical basic geometric shape, the at least one part of the holding device and/or of the accommodation device which is comprised of at least one portion of the Component Body, may be formed, e.g., on the outer perimeter of the Component Body, or on the inner perimeter of the Component Body, or on an inner surface of the Component Body which borders a hollow space within the Component Body. The term “outer perimeter” is understood to mean an outer skin surface, and the term “inner perimeter” is understood to mean an inner skin surface. A part of the holding device and/or of the accommodation device which is formed on the outer perimeter of the Component Body extends outwardly from said Component Body, in the radial direction (in relation to the central axis of the Component Body). A part of the holding device and/or of the accommodation device which is formed on the inner perimeter of the Component Body extends inwardly from said Component Body, in the radial direction (in relation to the central axis of the Component Body). It is readily apparent that the above-described part of the holding device or the accommodation device typically also has a certain extent along the outer or inner perimeter of the Component Body. Such a part of the holding device or the accommodation device which is formed on a corresponding inner surface [of the Component Body] does not extend inward from the inner perimeter (and/or outward from the outer perimeter) of the Component Body. The term “cylindrical basic shape” (or “hollow cylindrical basic shape”) should be understood to encompass also other geometric forms which might be candidates, e.g. ovals, ellipsoids, prisms, etc. Concrete examples of a Component Body having a “(hollow) cylindrical basic shape” are: elements for use in: a system for disposal of sewerage and/or wastewater and/or runoff water, a conduit (or shaft or manhole), a pole (or pile or post or column or pylon), a tunnel, or a tower (or castle). The preceding list of elements is not exhaustive.

For the example in which the Component Body, at least in some regions, in particular completely, has the basic geometric shape of a quadrilateral parallelepiped, in particular a rectangular parallelepiped (or cuboid), the at least one part of the holding device and/or of the accommodation device which is comprised of at least one portion of the Component Body, may be formed on an outer surface of the Component Body, or on an inner surface of the Component Body which borders a hollow space within the Component Body. The term “outer surface” should be understood to mean an exposed surface of the Component Body. When the Component is in an installed state in an object, e.g. a structure, the outer surface is typically visible; the same applies for a part of the holding device or accommodation device formed on it [(on said Component)]. A part of the holding device or accommodation device formed on an outer surface of a Component Body extends outwardly from the Component Body. The term “inner surface” should be understood to mean a surface of the Component Body which delimits a hollow space comprised of a recess in the Component Body, thus which delimits an “inner volume” of the Component Body. When the Component is in an installed state in an object, e.g. a structure, the outer surface is typically visible; the same applies as to the part of the holding device or accommodation device which is disposed on it [(i.e. on said Component)]. A part of a holding device or accommodation device disposed on an outer surface of a Component Body extends outwardly from the Component Body. The term “the basic geometric shape of a quadrilateral parallelepiped, in particular a rectangular parallelepiped (or cuboid)” should be understood to encompass also shapes which do not strictly fit this definition, such as, e.g., quadrilateral parallelepipeds having rounded corners, etc. Concrete examples of a Component Body having a basic shape of a “quadrilateral parallelepiped” are a wall element, a step element, and a support element. The preceding list of elements is not exhaustive.

In all cases, it is advantageous to provide at least one access opening which affords possible accessibility to the accommodation space. This space is delimited by the housing or by elements associated with the housing. The access opening may be comprised of the pass-through opening delimited by a platform (or by an element associated with the platform). The access opening may also be formed by a wall of the Component Body which borders (delimits) the housing which is associated with the holding device (or is associated with an element associated with the holding device). An example is a configuration in which the part of the holding device or the accommodation device formed by at least one portion of the Component Body is (essentially) completely formed in a wall of the Component Body. The access opening may also be formed by a wall of the housing (which is associated with the holding device) which is not formed by a wall of the Component Body.

The access opening can provide a means of direct access into the housing or into the accommodation space associated with the housing. It is also conceivable for the access opening to provide an indirect means of access into the housing or into the accommodation space associated with the housing. Under such an arrangement, possible access to the housing or to the accommodation space delimited by the housing (or by an element associated with the housing) is provided by an access channel which communicates with the access opening. A suitable access channel may have a flat extent, or may be configured, e.g., as a ramp, or a helical incline, or a helical staircase, which ascends (or descends) through a wall of the Component Body. The access opening which communicates with the access channel is formed in the wall of the Component Body. Depending on the specific geometric and structural characteristics of the Component Body, the access opening may be disposed and oriented, e.g., parallel to or at an angle to an exposed surface, particularly an exposed outer surface, of the Component Body. For the example of a Component Body having a (hollow) cylindrical basic shape, an access opening may be disposed and oriented, e.g., in the radial direction or in the circumferential direction. It may be advantageous to provide an access opening which is oriented in the circumferential direction if this results in impeding or preventing penetration of water into the holding device in the event that water tends to be present [at that level] due to splashing or surging.

In order to facilitate access to an access opening, an access platform may be provided, in particular a platform disposed or formed on or in the Component Body or on or in an element associated with the Component Body, which affords possible access to at least one access opening. Depending on the disposition and orientation of the access opening, the access platform can have a flat extent or can be configured, e.g., as a ramp, or a helical incline, or a helical staircase, which ascends (or descends) along a surface of the Component Body. As to the disposition and orientation of an access opening in relation to the (an) access platform, the range of possible choices is very broad; in any eventuality, the access platform will ensure access to the access opening.

Hereinbelow, possible functional and/or structural details of the device [(the Component)] will be described in more detail.

First, it should be mentioned that toxic substances and active ingredients contained in the baits which are or may be arranged in the housing associated with the holding device present possible risks to humans and the natural environment, and thus care must be taken that they do not escape into the environment around the housing associated with the bait holder, and/or around the Component Body, resulting in pollution, e.g. by penetration into groundwater.

In addressing this problem, the holding device is designed such that the region of the housing (which is associated with the holding device) in which the bait is or can be arranged is sealable, optionally hermetically sealable, whereby it is not possible for water to penetrate into this region of the housing. This establishes a general principle, namely that the above-stated problem of pollution of the environment around the housing (which is associated with the holding device), and around the Component, with substances contained in baits (poisons, active ingredients, etc.), is effectively solved, by means of the described configuration.

In general, the holding device can be designed so that, in the event of inflow or rising of water into or in the housing, the given volume (internal volume) and the sealing of the housing give rise to development of a physical back-pressure in the housing, which opposes and counteracts the said inflow or rising of water. This is due to the fact that the air in the housing is compressed by the inflow and the rising of water. The rising of water in the housing thus becomes increasingly difficult due to the counterpressure which develops. This principle is of course also applicable in the presence of multiple platforms, so that such a high physical counterpressure opposes the water rising in the housing when the water reaches a certain platform that the water can no longer rise. Here the housing is closed outside of the at least one pass-through opening.

Alternatively to having a closed configuration of the housing, it is conceivable to provide a housing with an “open” configuration, i.e. having at least one other opening other than one pass-through opening. The second opening is typically disposed or formed in a wall of the housing which is opposite to the at least one pass-through opening. The “open” configuration of the housing may be advantageous, e.g., in a situation where one desires to pass certain components, e.g. wires, cables, conduits, or pipes, (axially) through the housing. In connection with use of the device as a trap, in particular as a “living trap”, the second opening may be useful for a certain degree of exchange of oxygen with the environment. The dimensions of the second opening typically will be substantially smaller than those of the pass-through opening.

Advantageously, the device is comprised of at least one closure body. The closure body is mounted so as to be movable with respect to the platform, and is associated with the platform. The closure body can be moved between an open position and a closed position and optionally vice versa, relative to the platform. In the open position, the closure body is moved away from the platform in such a way that the pass-through opening, which is delimited by the platform, is essentially open. Accordingly, when the closure body is in its open position, a pest can negotiate the pass-through opening and can pass into and out of the upper region (of the housing). In the closed position, the closure body is moved toward the platform in such a way that the pass-through opening, which is delimited by the platform, becomes closed off. Accordingly, when the closure body is in its closed position, a pest cannot negotiate the pass-through opening and cannot pass into or out of the upper region (of the housing). In the closed position, the closure body closes off the pass-through opening, typically creating a hermetic seal. Accordingly, when the closure body is in its closed position, the region [of the housing] above the pass-through opening is typically closed off, typically in a hermetic seal. When the closure body is in its closed position, the region [of the housing] above the pass-through opening is separated from the region [of the housing] below the pass-through opening, so that it is not possible for water to penetrate into the region [of the housing] above the pass-through opening, in which region typically the bait is arranged. This establishes a general principle, namely that the problem of pollution of the environment around the Component with substances of which the bait is comprised is effectively solved[, by means of the described closure means].

Means of supporting the mounting of the closure body so that the closure body is movable may be assisted structurally by at least one “guide segment” associated with the housing, and least one “partner guide segment” which cooperates therewith and is associated with the closure body. The “guide segment” associated with the housing may be in the form of, e.g., a guiding element having the characteristics of a groove or channel, and the “partner guide segment” associated with the closure body may be in the form of, e.g., a rail element or another supported structural feature which engages in the “guide segment”.

A preferred means of mounting of the closure body so that the closure body is movable comprises at least one clamp-type or bracket-type holding element which is movable, preferably swingable, and which is attached to or mounted in the housing, in particular being mounted to a platform. A corresponding holding element, to be referred to also as a holding clamp or a holding bracket, is typically fastened, on the one hand, in particular on one end, to the housing and/or to a platform, and on the other hand, in particular at the other end, to the closure body. A certain path of movement which the closure body traverses in movement from the open position into the closed position and vice versa, is defined by the connection of the closure body to the holding element, the connection of the holding element to the housing and/or the platform, and the geometric dimensions and parameters, in particular the shape, of the holding element.

The clamp-type or bracket-type holding element may be comprised of at least two “holding element segments” which extend in parallel or at an angle to one another, wherein at least one “holding element segment” engages through the pass-through opening delimited by the platform or an element associated with the platform, at least in the open position of the closure body. Relevant “holding element segments” and indeed the entire holding element may be bent, e.g. in an L shape, i.e. having an (essentially) L-shaped geometric shape.

The closure body may be in the form of, or may at least be comprised of, a buoyant body (float). The term “buoyant body” should be understood to mean a body which floats on the surface of water and does not sink. This can be arrived at by at least one closed body comprising a hollow space which may be filed with, e.g., air. Alternatively or additionally, the closure body may also be fabricated from a low-density material, which then floats on the surface of water based on the difference in the densities, and does not sink. Such a material may comprise, e.g., plastic, in particular a foamed plastic. Specifically the plastic may comprise, e.g., one or more thermoplastic foam materials, such as polyethylene foam or polystyrene foam. A movement of the closure body from the open position into the closed position is thus induced essentially by a rise in the water level. Similarly, a movement of the closure body from the closed position into the open position is induced by a decrease in the water level. The means by which the closure body is mounted or disposed relative to the housing (which is associated with the holding device essentially render the closure body freely movable.

The closure body may have at least one closure region which has the shape of, e.g., a segment of a sphere or cone, wherewith in the closed position of the closure body at least part of this closure region sealingly abuts one or more suitably configured engaging regions disposed on edges associated with the platform, which themselves delimit the pass-through opening delimited by the platform or by an element associated with the platform. Due to the sealing contact of the closure body, i.e., the forced contact of the contact segments provided on the closure region associated with the closure body, with the engaging regions disposed on edges associated with the platform, which themselves delimit the pass-through opening delimited by the platform, water cannot penetrate into the housing, particularly into the upper region of the housing. Advantageously, the contact surfaces associated with the platform which delimit the pass-through opening are provided, in at least part of their extent, with a sealing element, e.g. a sealing ring, a sealing lip, etc. Similarly, the closure region associated with the closure body may be provided with suitable sealing elements on at least part of its extent, in particular in regions adapted to engage other closure elements [associated with the platform].

In order to facilitate access of a pest to the platform, the closure body may be provided with suitable inclined surfaces. Suitable inclined surfaces may be provided, e.g., by a closure body which has a trapezoidal cross section. It is also conceivable to provide at least one auxiliary means, in the nature of a belt, strip, or chain, which extend(s) from the platform toward the closure body and back, or from the closure body into a region around the closure body and back, and generally serves to facilitate and simplify entry into and exit from the housing [(by a pest)]. Such auxiliary means is/are designed so as not to interfere with [closure and] the closed position of the closure body.

To further facilitate access by a pest to the platform, the closure body may be provided with at least one region having surface structuring and/or (possibly adhesive) surface coating and/or surface overlayering, to improve the traction of a pest (and prevent slippage of a pest) which is engaging the closure body. Such a surface structuring and/or surface coating and/or surface overlayering inhibits or prevents slippage of the pest from the closure body, thus serves as an entry or exit aid, facilitating entry into and exit out of the receptacle chamber delimited by the housing or by elements associated with the housing. The at least one region of surface structuring, typically three-dimensional, improving the traction offered to a pest entering the closure body may be formed, e.g., by corrugations and/or ridge structures and/or groove structures, in the surface of the closure body. Another suitable type of surface structuring may comprise rung-type or step-type structures in a surface region of the closure body. A certain roughening of the surface may provide suitable surface structuring. In general, any coatings which improve the traction of a pest on the closure body, e.g. based on natural or synthetic rubbers, silicones, etc. may be applied to at least some regions of the surface of the closure body. The at least one surface overlayering may be formed, e.g., by a rubbery surface coating or surface layer applied in at least some regions to the surface of the closure body. Such a surface overlayering may be bound to the closure body by suitable means, which may be any suitable means involving, e.g., form-interlocking engagement and/or forcible engagement (e.g. frictional or clamping) and/or direct bonding (e.g. thermal bonding or welding) and/or adhesive bonding; a few among many possible examples are clip fastening, gluing, screw fastening, embossing, etc. For the example of a closure body in the form of a spherical segment, a suitable surface structuring and/or surface coating and/or surface overlayering may be disposed or formed in at least some parts of a circular region on the surface of the closure body.

A plurality of platforms may be disposed one above another in the housing, wherewith an intermediate space defining an intermediate level may be formed between two neighboring platforms. Depending on the geometric configurations and dispositions of the platforms, a plurality of platforms may be parallelly oriented, at least with regard to part of their areas. Individual intermediate spaces communicate with each other via respective pass-through openings delimited by the platforms; thus a possibility is provided of passage through two immediately neighboring platforms. The respective intermediate spaces need not be the same with respect to their shape, their volume, etc., but instead may be different.

If a plurality of platforms are provided, it is advantageous if at least one closure body is mounted so as to be movable relative to at least one platform, wherein, in its open position, the closure body is displaced away from the respective at least one platform, such that the respective at least one pass-through opening which is delimited by the platform or by an element associated with the platform is exposed, and in its closed position the closure body is displaced toward the respective at least one platform, such that the respective at least one pass-through opening delimited by the platform or by an element associated with the platform is closed. The above-described principle of using a closure body to hermetically seal a pass-through opening delimited by the platform (or by an element associated with the platform), wherewith the closure body is moved into a corresponding closed position, is also applicable here.

By providing multiple platforms and multiple intermediate spaces, it is possible to supply the housing with a relatively large number of baits, because baits can be disposed in principle at a plurality of levels. This will provide the opportunity for a larger number of pests to frequent the housing. In addition, the mechanical stability, in particular the rigidity, of the housing is increased by the presence of a plurality of platforms; thus, the housing is “stiffened” by the platforms.

By providing a plurality of platforms, along with corresponding intermediate spaces, generally one can also achieve “calming” (moderation) of any flow of water rising in the housing. The water flowing into and rising in the housing must travel upward along a path extending over a plurality of intermediate levels, which typically leads to a “calming” of the flow of the water. In addition, some or all of the platforms may be provided in at least some regions with surface structuring, e.g. in the form of flow-influencing ridge structures and/or groove structures, which tend to influence the type of flow and/or the velocity of flow of water rising in the housing.

The respective pass-through openings delimited by the respective platforms may be disposed so that they are offset relative to one another. In general, at least one pass-through opening, which is delimited by a first platform (or by an element associated with said platform), may be disposed so that it is offset from a pass-through opening which is delimited by a second platform (or by an element associated with said second platform) which neighbors the said first platform. For example, a pass-through opening of a first platform may be disposed in an edge region of the first bait platform, and a pass-through opening in a second platform which neighbors the first platform may be disposed in a corresponding opposite edge region of the second platform. Due to the offset arrangement of the respective pass-through openings, a “calming” or in general a desired influence on the flow of water rising in the housing is thus possible. The offset arrangement of the respective passage openings can also facilitate the movement of a pest between the respective intermediate spaces and/or intermediate levels.

At least one platform may be provided in at least some regions with at least one platform area which is inclined, or bent, and/or curved, relative to at least one other platform disposed in particular in proximity to (neighboring) it. By providing for suitable relationships of these features (the respective inclined and/or bent and/or curved profiles of various platforms), the flow of water rising in the housing can also be desirably influenced. Inclined and/or bent and/or curved profiles of various platforms can also facilitate the movement of pests upward and/or downward between the respective intermediate spaces and/or intermediate levels, to the extent that the platforms provide suitable ramp configurations.

Independently from the provision of a plurality of platforms, as an additional measure for influencing the flow of water rising in the housing, basically at least one platform can be provided, at least in some regions, with bore-like openings or perforations which extend through the platform. The openings in a platform, similarly to pass-through openings, in general can “dampen” the flow of rising water and can thus “calm” it. The openings are present in addition to the pass-through openings delimited by the respective platforms (or by elements associated with the platforms), and they may differ in particular in their size (e.g. their diameter) from the said pass-through openings, namely they are smaller than said pass-through openings. Roundish such openings, e.g., may have a diameter between 50 μm and 3 mm. It is self-evident that various openings may be provided which have different geometric dimensions.

In addition, again basically independently of the provision of a plurality of platforms, it is generally possible for a platform, in at least some regions of the platform, to extend through at least a part of the housing with the platform being in a spiral or helical configuration. A pest penetrating into the housing can easily move inside the housing, e.g. to access a bait, over a platform configured in a spiral or helical form, e.g. similar to a spiral staircase. Spiral and/or helical bait platforms may also have an influence on the flow of water rising in the housing. If a plurality of platforms is provided, it is possible for one or more platforms to be provided, in at least some regions of the platform, with a suitable spiral and/or helical shape (of progression).

Also in general, i.e. basically independently of the provision of a plurality of platforms, the closure body can be mounted so as to be movable back and forth between the open position and the closed position, wherewith when in the closed position it can be moved back into the open position without external intervention, and vice versa. Alternatively, the closure body may be mounted so as to be irreversibly movable between the open position and the closed position, wherewith closure body holding means may be provided to hold it in the end position; however, it is also possible for the irreversibility to be made releasable. The closure body in the closed position thus cannot move into the open position on its own. Accordingly, the device may be utilized as a trap, in particular a so-called “living trap” (live animal trap), for pests.

If a device is provided for holding the closure body, it may be comprised of at least one mechanical and/or magnetic holding means on the housing and/or on the closure body (or on elements associated with these), which is designed for mechanical and/or magnetic holding of the closure body in its closed position. The mechanical and/or magnetic holding means on the housing and/or on the closure body (or on elements associated with these) may thus interact with one another such that the closure body is securely held in the closed position and cannot be released therefrom without special intervention. A mechanical holding means may be comprised of, e.g., catch and/or snap elements, which participate in mechanical holding of the closure body in the closed position. The catch and/or snap elements may comprise, e.g., projections and corresponding recesses, undercuts, etc. Depending on the structural design of the catch and/or snap elements, the holding brought about may be releasable or non-releasable. A magnetic holding means may be comprised of, e.g. in particular permanent magnet elements, which participate in magnetic holding of the closure body in the closed position, as a result of magnetic interactions. In this context, it is also conceivable, e.g., for a magnet element associated with the housing to be disposed such that it exerts a magnetic force on a magnetic element associated with the closure body, thereby tending to hold the closure body in the closed position when the closure body approaches the closed position or is in the closed position. The magnetic force should not be so great that when the closure body is in the open position it is moved into the closed position solely because of this force. If the closure body is itself fabricated from a magnetic or magnetizable material, it may optionally be possible to omit separate magnet elements on or in association with the closure body. The housing and/or the closure body fundamentally may be comprised of suitable magnet elements.

Apart from the basic possibility of mounting the closure body with means whereby it is freely movable relative to the housing (which is associated with the holding device [for the housing]), the holding device may be comprised of at least one drive means which is/are coupled or couplable to the closure body. This drive means can bring about movement of the closure body, in particular movement from the open position to the closed position, and/or vice versa. Thus movements of the closure body may be induced by a drive device which is coupled or couplable to the closure body. The drive device may be comprised of a control unit which is designed to generate control information for controlling the operation of the drive device.

The drive device may be in the form of, or may at least be comprised of, e.g., a motor-driven drive means. At least one motor-driven drive device, e.g. in the form of an electric motor, may be provided, which is coupled to or is couplable to the closure body and is designed to bring about movement of the closure body based on a motor-generated driving force. The coupling between the motor-driven drive device and the closure body may be implemented by means of at least one traction means, e.g. in the form of a tensile belt or tensile chain.

Alternatively or in addition, the drive device may be in the form of, or may at least be comprised of, a magnetic drive means. At least one magnetic drive device may be provided, which is coupled to or is couplable to the closure body and is designed to cause movement of the closure body based on a magnetically generated driving force. The magnetic drive device typically comprises at least one magnetizable and/or magnetic magnet element which is associated with the housing (which is associated with the holding device [for the housing]) and[/or] which magnet element is associated with the closure body. The magnet elements, one associated with the housing and one with the closure body, mutually interact magnetically, whereby a magnetic force of attraction sufficient to move the closure body may be generated. Both electromagnetic and permanent-magnet magnet elements may be considered. A “magnetizable magnet element” may comprise, e.g., an electromagnet, which when a current is applied generates a magnetic force of attraction; a “magnetic magnet element” may comprise, e.g., a permanent magnet, which has a static magnetic field and continuously generates a magnetic force of attraction.

In this context, different configurations are conceivable. It is possible to provide at least one electromagnetic magnet element which can be energized when needed, in association with the housing, and to provide a permanent magnet element in association with the closure body, wherein when the electromagnetic element is subjected to a current it interacts with the permanent magnet magnetic element, whereby the closure body is caused to move as a result of the magnetic attraction. Conversely, it is possible in principle to provide at least one electromagnetic magnet element in association with the closure body and at least one permanent magnet element in association with the housing. Similarly, electromagnetic magnet elements may be provided in association with both the housing and the closure body; or permanent magnet elements may be provided in association with both the housing and the closure body.

In the case in which a permanent magnet element is present in association with both the housing and the closure body, the magnetic attraction may be sufficient such that, when the magnetic element associated with the closure body comes sufficiently close to the magnet element associated with the housing, the closure body will be moved from the open position into the closed position as a result of said magnetic attraction. Sufficient proximity can be achieved, for example, when a closure body designed as a float or comprising at least one such float is moved, e.g. due to rising water, by a certain distance in the direction of the closed position, starting from the open position, namely to a certain position between the open position and the closed position. Self-evidently, the magnetic attraction, i.e. the interaction between the respective permanent magnet elements, ought not to be so high that a closure body located only in the open position is moved into the closed position merely because of this attraction.

Individual magnet elements associated with the holding device and with the closure body may be disposed so that, at least in regions, they are exposed on surfaces of the holding device and of the closure body, respectively; or such magnet elements may be disposed interiorly of (integrated into) the holding device and the closure body, respectively, where they are not exposed [on such surfaces]. It is also possible for the holding device and/or the closure body to be comprised of a magnetic or magnetizable material, such as e.g. ferritic steel, or of a material which has a filling comprising magnetic or magnetizable particles, which material may comprise, e.g., plastic; such compositions may be present over the entire extent of the object or only in certain regions of the object.

As mentioned, the described embodiments may utilize a control unit associated with the drive means, which carries out control of the operation of the various drive means. The control unit may additionally be designed to generate control information depending on certain status information provided by a suitable “detection device” for detecting or determining, e.g. the water level in, e.g., a shaft or manhole in which the Component is disposed. Thus, the drive means may be operated as a function of, e.g., the water level as represented by information determined by a suitable “detection device” and delivered as a suitable signal. In principle, the control unit may be designed to respond to certain critical conditions, e.g. critical water levels, in particular penetration of water into the housing, especially a certain region (e.g. the upper region) of the housing where the bait is arranged. Accordingly, the control unit can timely send appropriate control information to the drive means, in order to prevent penetration of water into the housing, in particular into the region of the housing where the bait is arranged.

Also, the “detection device” can be designed to communicate with at least one external communication device via a transmitting and/or receiving device associated with said “detection device”. For example, information about a high water level which is developing can be timely sent to the transmitting and/or receiving devices associated with the “detection device”. Data may be exchanged with an external communication device by means of a transmitting and/or receiving device, possibly modular in design, associated with the “detection device”, with the data exchange being in particular radio-based, i.e. via Bluetooth, DECT, WLAN, etc.

The described device [(the Component)] may also be comprised of a device which detects a closed status (referred to here as a “closed-position-detecting device”), which may be namely the closed position of the closure body. The “closed-position-detecting device” is typically disposed in the housing, and is equipped to generate at least one acoustic and/or optical closed-position information item upon detection of the closed position of the closure body and to output it via at least one output means. This makes it possible to detect when the closed position has been reached and to easily display this fact via acoustic and/or optical signals, which may be expedient in particular under circumstances of service work or repair work. It is thus possible to, e.g., display for the service or repair personnel the fact that a high water level has been reached or is being reached in the region around the Component, on the basis of which the closure body has been moved into the closed position or is still being held in the closed position. Consequently, the “closed-position-detecting” device comprises a suitable sensor system for detecting the closed position or closed status of the closure body. The sensor system may comprise, e.g., optical means, e.g. employing photoelectric sensors.

The described device [(the Component)] may also be comprised of a device which detects biting, namely biting into a bait. The bite-detecting device, which may be disposed, e.g., in the housing, is designed to generate at least one acoustic and/or optical item of bite information upon detection of bait that has been or is being bitten into, and to output this information via at least one output means. This makes it possible to detect a bite on the bait [by a pest] and to indicate this via acoustic and/or optical signals in a simple manner; this capability may be expedient under circumstances of service work or repair work. It is thus possible to, e.g., display for the service or repair personnel the fact that a bite on the bait has occurred and that therefore it is necessary to check whether a new bait ought to be inserted into the housing. Consequently, the bite-detecting device comprises a suitable sensor system for detecting a bite on the bait. This sensor system may determine, e.g., the weight or volume of the bait, wherewith a change in the weight or volume of the bait, typically a reduction, will suggest that the bait has been bitten into. Similarly, the sensor system may be devised to detect bite-related forces, typically tensile forces acting on the bait and/or the bait-holding device, which indicate that the bait is undergoing a bite.

The bite-detecting device may generate various acoustic and/or optical signals, depending on the bite information. The weight or volume of a new bait that has not been bitten into can be signaled, e.g., with optical signals of a green color and/or with continuously emitted optical signals; the weight or volume of a partially bitten bait can be signaled, e.g., with optical signals of a yellow color and/or optical signals emitted at a first blinking frequency; and if the bait has been completely eaten, this can be signaled, e.g., by optical signals of a red color and/or with optical signals emitted at a second blinking frequency which is higher than the first blinking frequency. Clearly, an analogous scheme can be adopted for the emission of acoustic signals, wherein in particular the frequency and/or the rhythm of a tone and/or a tone sequence may be varied depending on the bite information. The situation is of course similar in circumstances where the bite-detecting device draws inferences regarding a bite into the bait, based on other measured variables other than the weight or the volume.

An acoustic output means for emitting acoustic signals may comprise, e.g., a loudspeaker. An optical output means for emitting optical signals may comprise, e.g., a light-emitting diode, in particular with multicolor capability, or a display screen.

The output means may be disposed on or in the housing, in particular on an exposed exterior surface of the housing or inside an accommodation space delimited by the housing or by an element associated with the housing. In particular for optical output means, if said means are disposed within the housing, i.e., within an accommodation space in the housing delimited by the housing or by an element associated with the housing, then the housing may be designed to be at least partially transparent in order to make the optical signals also recognizable from outside of the housing.

One or more output means may also be integrated into an external mobile terminal. If output means are integrated into an external mobile terminal, the “closed-position-detecting device” and/or the bite-detecting device may be designed to communicate with the external mobile terminal and to transmit data, particularly closed-position information and/or bite information, to the external mobile terminal, e.g. for output by the output means disposed there and/or for storage by data storage means (memory) disposed there. Service or operating personnel can also be informed that a closure body is in the closed position and/or that a bait has been bitten into, without having to approach or inspect the Component. The described communication may be radio-based, in particular, e.g. via Bluetooth, DECT, WLAN, etc. Accordingly, the “closed-position-detecting device” and/or the bite-detecting device may be associated with a transmitting and/or receiving device, possibly modular, which enables data exchange via radio-based means, e.g. Bluetooth, DECT, WLAN, etc. The external mobile terminal may comprise, e.g., a cellphone, smart phone, tablet computer, notebook computer, or other portable electronic device.

In view of the appreciable number of electrical and/or electronic elements which may come to be disposed in the housing, in particular drive means and/or “detection devices” and/or control devices, it may be advantageous for at least one “accommodation chamber” to be provided in an accommodation space delimited by the housing or by an element of the housing, for accommodating electrical and/or electronic elements of the described device. The accommodation chamber offers protection for these elements against external influences, in particular climatic and mechanical influences. The “accommodation chamber” may be designed to be an integral part of the housing or as a separate part, which is to be inserted separately into the accommodation space in or associated with the housing. Access to the accommodation space delimited by the housing or by an element of the housing may be provided by removal of the “accommodation chamber”. A cover element may be provided to close off the “accommodation chamber” (or to enable it to be closed off).

The “accommodation chamber” may be provided with an “accommodation chamber body” which delimits a cylindrical or quasi-cylindrical “accommodation volume” for accommodating electrical and/or electronic elements of the described device. The “accommodation chamber body” typically extends into the accommodation space associated with the housing, or so extends at least in some regions.

The “accommodation chamber” is releasably attached (or attachable) to the housing in a manner such that it can be removed without destruction or damage. The releasable attachment of the “accommodation chamber” to the housing is (or can be) realized by interaction, particularly form-interlocking interaction, between at least one attachment area on or associated with the housing and at least one partner attachment area on or associated with the “accommodation chamber”. The term “interaction, particularly form-interlocking interaction” between an attachment area and a partner attachment area should be understood to refer to, e.g., interengagement or overlapping engagement of said areas, at least in parts of said areas.

The “accommodation chamber” may be mounted (or capable of being mounted) on the housing so as to be rotatably movable between a fastened position and a released position. In the fastened position, the at least one attachment area associated with the housing and the at least one partner attachment area associated with the “accommodation chamber” cooperate, in particular in a form-interlocking manner, so that the “accommodation chamber” is attached to the housing in a stable manner. In the released position, the at least one attachment area associated with the housing and the at least one partner attachment area associated with the “accommodation chamber” do not cooperate, so that the “accommodation chamber” can be removed from the housing. The attachment of the “accommodation chamber” to the housing can thus be established by rotational movement of the “accommodation chamber” relative to the housing, about an axis of rotation which typically coincides with the central axis of the “accommodation chamber”; and the attachment thus established can be subsequently released, by reversing the rotational movement. Thus, the “accommodation chamber” can be converted from the fastened position to the released position and vice versa by rotational movements relative to the housing.

To bring about appropriate rotational movements of the “accommodation chamber”, the “accommodation chamber” may be provided with at least one tool-engagement region for form-interlocking engagement of a tool, rotational movements being transferable to the “accommodation chamber” by means of said tool to convert the “accommodation chamber” from the fastened position to the released position and vice versa. Due to the configuration and disposition of at least one suitable tool-engagement region in the region of an exposed upper area of the cover member of the “accommodation chamber”, the tool-engagement region is always accessible (from above). The geometric design of the tool-engagement region is such that a tool, e.g. a T-shaped tool, can engage said region in a form-interlocking manner, so that torques can be applied to impart rotational movements to the “accommodation chamber”.

Particularly when the Component is properly installed (as particularly intended), e.g. as a component which forms a channel element in a channel, shaft, or manhole, the tool-engagement region is amply accessible, particularly from above. As a result of appropriate shaping and dimensioning of the abovementioned tool, it is not absolutely necessary for a user to enter the shaft itself, e.g. climb down into the manhole, in order to bring the “accommodation chamber” from the fastened position into the released position or vice versa, by executing the corresponding rotational movements. The “accommodation chamber” may thus be removed from the housing by a user located above ground and outside of the shaft (e.g. manhole); and if desired the “accommodation chamber” may be removed from the shaft as well. If the bait is held by means of a bait-holding device disposed on the “accommodation chamber”, the “accommodation chamber”, including the bait-holding device and the bait held thereon, can be removed from the shaft (e.g. manhole) without any entry into the shaft by the user, any bite into the bait can be detected, the bait can be changed or replaced, if necessary, and the “accommodation chamber” together with the bait-holding device and the bait held thereon can be re-introduced into the shaft. This may be done, e.g., for purposes of inspection, e.g. to ascertain whether there has been a bite on the bait; and thereby inspections may be performed in a practicable, substantially simplified, and substantially more rapid manner.

At least one monitoring device, in particular optical, for monitoring at least part of the accommodation space delimited by the housing or by elements of the housing, may be disposed on or in the “accommodation chamber” or another part of the housing. In general, the monitoring device is designed or disposed such as to enable the most extensive possible monitoring of the accommodation space delimited by the housing (or by elements associated with the housing). The monitoring device typically is comprised of a suitable sensor system, in particular optical, for monitoring at least a part of the said accommodation space delimited by the housing (or by elements associated with the housing). The monitoring device may thus be in the form of or may be comprised of, e.g., an infrared sensor system and/or infrared camera. Self-evidently, in general the monitoring device may be embodied in a different way. For example, it would be conceivable for a monitoring device to be in the form of a video camera or CCD camera. The monitoring data supplied by the monitoring device can be sent to an external communication device. It is readily apparent that the Component, in particular the monitoring device, may be provided with transmitting and/or receiving devices, possibly modular in design, which are suitable for this purpose, which enable data exchange with an external communication device, with the data exchange being in particular radio-based, i.e. via Bluetooth, DECT, WLAN, etc.

Without describing the concrete means employed, it may be stated that the monitoring device enables one to detect and evaluate any process occurring in or in a region of the accommodation space delimited by the housing (or by elements associated with the housing). In particular processes related to pests can be detected and determined qualitatively and/or quantitatively, and can be further evaluated. Processes of particular interest which can be monitored quantitatively and/or qualitatively include, e.g., entrance by pests into the receptacle chamber (bait accommodation space), egress by pests out of the receptacle chamber, the behavior, i.e., in particular biting and/or movement behavior of the pests which enter the receptacle chamber, while they are in said chamber, etc. In general, the number of pests entering (“the pests frequenting”) the receptacle chamber per unit of time can be determined, on a qualitative and/or quantitative basis, and can be subjected to evaluations. It is self-evident that monitoring information and/or data detected and determined by the monitoring device can be transmitted over a suitable, in particular radio-based, communication link to an external terminal, in particular a mobile terminal associated with the user; therefore it is possible to “monitor” all processes in the receptacle chamber of the housing, by means of a suitable monitoring device, without a need for the user to physically enter the Component. The external terminal, which may be mobile, may comprise, e.g., a cellphone, smart phone, tablet computer, notebook computer, or other portable electronic device.

The monitoring device may be supplied with electrical energy via an electrical energy storage means, which is disposed, e.g., in the accommodation chamber, and which may be rechargeable. An electrical energy storage means which might be used is, e.g., a rechargeable battery. A conceivable rechargeable energy storage means, is, e.g. an energy storage device which is rechargeable via electromagnetic induction. In principle electrical energy may also be supplied to a monitoring device via a hard-wired connection thereof to an energy supply network (e.g. electric power mains). The situation is similar as regards supply of electrical energy to other electrical and/or electronic elements of the described device [(the Component)].

The described device [(Component)] may be comprised of at least one surge protection element (water surge protection element) for protection against penetration of water into the receptacle chamber which is delimited by the housing (or by elements associated with the housing)—in particular into the upper region of the receptacle chamber which is located above the pass-through opening which is delimited by the platform (or by elements associated with the platform), in the event that the water level rises suddenly (water surge). The surge protection element is typically disposed beneath the (lowest) platform. The surge protection element may be disposed inside or outside of the housing, in at least some areas. At least one part of the surge protection element may be formed by at least one region of the Component Body, and thus may be physically integrated with said Component Body.

The surge protection element may have a base body, which delimits at least one water surge accommodation volume for accommodating a certain amount of water. The base body of the surge protection element may be, e.g., of a cylindrical or quasi-cylindrical shape. Polygonal or in particular quadrilateral base shapes [(i.e. prismatic shapes with a polygonal or quadrilateral cross section)] are also conceivable. If a closure body is provided, the closure body is mounted to be movable in at least one or more regions inside the base body of the surge protection element, such that it is moved from the open position into the closed position when the water level in the water surge accommodation volume increases due to penetration of water into said volume. The base body of the surge protection element may be comprised of a plurality of bearing elements, which may be configured as, e.g., leg members or web members, which are used as part of the mounting means of the surge protection element.

The base body of the surge protection element may be comprised of a bottom surface having at least one inlet opening for surge water, in the region of its side facing away from the (lowest) platform. If a closure body is provided, the closure body when in the open position may be disposed, in at least part of its (the closure body's) extent, in the inlet opening for surge water. With a rise in the water level, the closure body, which in particular may be in the form of a buoyant body (float) is lifted up from the surge water inlet opening, so that water can enter the water surge accommodation volume, until the closure body, as a result of the rise of the water level in the water surge accommodation volume, is finally moved from the open position into the closed position. Self-evidently, it is also conceivable for the base body of the surge protection element to be completely open in the region of its side facing away from the (lowest) platform. In this case, the closure body may be held via suitable holding means.

Hereinbelow, possible functional and/or structural details of the (basically optional) accommodation device will be described in more detail.

If an accommodation device is provided, it is designed for accommodating the holding device, and for this purpose it delimits a separate accommodation space having, e.g., a channel configuration or tubular configuration. The accommodation device may have a (first) access opening, through which a pest can access the accommodation space associated with the accommodation device, and thereby can proceed farther (in the event that the holding device is disposed (is being accommodated) in the accommodation space) into the housing associated with the holding device, and/or into the receptacle chamber delimited by the housing (or by elements associated with the housing). The accommodation device may have at least one “additional access opening”, through which the holding device may be inserted into the accommodation space associated with the accommodation device, and/or through which a holding device accommodated in the accommodation space can be removed from the accommodation space. The “additional access opening” is typically larger (e.g. substantially larger) than the “first access opening”. The different such access openings are typically disposed in different regions, particularly at opposite ends, of the accommodation device. The “additional access opening” (e.g. second access opening) can be provided with a movably mounted closure element which can be moved between an open position, allowing the (or a) holding device to be inserted into or removed from the accommodation space, via said “additional access opening”, and a closed position, preventing said holding device from being inserted into or removed from the accommodation space. Depending on the geometric and structural configuration and disposition of the accommodation device, the closure element may comprise, e.g., a flap element or the like.

A guiding device may be provided which is associated with the accommodation device, which guiding device is designed for movable guiding of (i.e. designed for guiding the movement of) a holding device disposed in the accommodation space associated with the accommodation device, namely movement in said accommodation space, particularly relative to the Component Body. Thus, the holding device is not disposed at a fixed position on the Component Body, but rather is movable relative to the Component Body, with movements which are guided. With the guiding device, it is possible for the holding device which is accommodated in the accommodation space to move under the influence of guiding (to guidedly move) in said accommodation space, particularly in linear movement. Movements of the holding device typically occur along a vertically oriented axis of movement, particularly a linear such axis. The guiding device (guide means) may be provided with suitable guiding elements, e.g. guide grooves or projections, which cooperate with suitable partner guiding elements, e.g. suitably configured guide projections or guide grooves, on or associated with the holding device, in particular on or associated with the housing, forming means of guiding the holding device in, e.g., linear movement inside the accommodation space.

The guiding device may further be comprised of at least one, typically a plurality of wheel-type or roller-type guide element(s), via which the holding device is rollingly guided along the wall(s) bounding the “accommodation chamber” associated with the accommodation device. Corresponding wheel-type or roller-type guide elements may be in direct contact with the wall of the “accommodation chamber”, so that no special measures are necessary for guiding the holding device in movement along the relevant walls. In the case of multiple wheel-type or roller-type guide elements, these are typically disposed in an equidistant arrangement on or around the housing which is associated with the holding device.

The wheel-type or roller-type guide elements may be rollably mounted on the “holding means” disposed on the holding device. The wheel-type or roller-type guide elements may be braced or braceable, particularly by means of urging force, against the wall(s) which delimit(s) the “accommodation chamber” associated with the accommodation device. The “holding means” may be comprised of at least one holding arm mounted on the housing (which is associated with the holding device) so as to be swingable (or flappable) thereon (e.g. by hinge or flap means), namely swingable (or flappable) against a wall which delimits the “accommodation chamber”. The holding arm may be coupled to at least one urging or stressing element, in particular a spring element, e.g. in the form of a compression spring, by means of which urging or stressing element an urging or stressing force, in particular a spring force, which braces the guide element against the wall(s) which delimit the “accommodation chamber”, is exerted or exertable on said holding arm. The urging or stressing elements are typically disposed between the housing (which is associated with the holding device) and a holding arm. By means of such a “holding means”, the holding device can be inserted into various accommodation spaces having different dimensions, and can be braced (in particular at an angle) against the walls which delimit these accommodation spaces.

Alternatively or additionally, the “holding means” may be comprised of at least one holding arm which can be lengthened, in particular telescopically, being extendable in particular in the radial direction (with respect to the axis of symmetry or the central axis of the housing, or of the accommodation space associated with the accommodation device), and toward a wall which delimits the accommodation space. The holding arm may be coupled to at least one urging or stressing element, in particular a spring element, e.g. in the form of a compression spring, by means of which urging or stressing element an urging or stressing force, in particular a spring force, which braces the guide element against the wall(s) which delimit the “accommodation chamber”, is exerted or exertable on said holding arm. By means of such a “holding means”, the holding device can be inserted into various accommodation spaces having different dimensions, and can be braced (in particular radially) against the walls which delimit these accommodation spaces.

The described possible means of holding and bracing the holding device inside the accommodation space associated with the accommodation device enable the holding device to be positioned in a reliable manner, inside said accommodation space. The urging or stressing force is typically selected so that uncontrolled downward movement (sinking) of the holding device is prevented, while vertical movements of the holding device, e.g. in the direction of a manhole cover or other shaft cover, and/or in the direction of an upper manhole opening or other shaft opening, are made possible. Vertical movements of the holding device may be induced (as will be described hereinbelow) in particular by forces resulting from penetration of water into the accommodation space.

The guiding device may also be comprised of at least one guiding element, in particular a gearwheel-type or toothed-rack-type guiding element, associated with the holding device, and at least one partner guiding element, in particular a gearwheel-type or toothed-rack-type guiding element, associated with the wall, which partner guiding element interacts (cooperates) with the aforesaid guiding element, wherewith these guiding elements serve to guide the holding device in (potential) linear motion along the wall which delimits (bounds) the “accommodation chamber” associated with the accommodation device. In this case, the guiding device also is comprised of [partner] guiding elements, associated with walls, in particular guide elements of a gearwheel or toothed-rack type. The described guiding elements and partner guiding elements, associated with the holding device and with walls, respectively, engage mechanically, particularly by positive coupling interengagement (not mere frictional interengagement), to accomplish linear guiding. In addition to linear guiding elements of the gearwheel type or toothed-rack type, any guide elements which are effective as between the holding device and the wall(s), may be considered, if they enable linear guiding of the holding device relative to a wall (or walls) delimiting the “accommodation chamber”.

The guiding device may be comprised of at least one drive device, particularly a motor-driven drive device, e.g. an electric motor, which is coupled to or couplable to a guiding element, which drive device is designed to transmit a drive force to the guiding element which drives the latter in a unidirectional or bidirectional driven movement. The drive device may be disposed on or in the housing associated with the holding device. Alternatively or additionally, the drive device may also be disposed or formed on or in a suitable guiding element, e.g. the drive device may be integrated into or onto a suitable wheel-type or roller-type guiding element, or may be disposed in a gearwheel.

The guiding device may be comprised of at least one profile-type or rod-type guiding element which is or can be attached in the “accommodation chamber” associated with the accommodation device and which is disposed on, or passes through (particularly axially) the holding part (particularly the housing). With this arrangement, the holding device is guided such that it is movable, in particular linearly, relative to the profile-type or rod-type guiding element. Typically, mounting means are also provided for mounting the holding device on the guiding element, which in turn is attached to elements of the “accommodation chamber”. It is not necessary that the guiding element directly abut against a wall bounding the “accommodation chamber”; e.g. it may be disposed centrally in the interior of the “accommodation chamber”. A guiding element which passes (typically axially) through the holding device does not impede the function described above in connection with a movably mounted closure body associated with the holding device; in particular, it does not impede the movement of the closure body.

At least one buoyant body (float) may be disposed on the holding device, in particular on the housing, to move or aid in moving the holding device in the “accommodation chamber” associated with the accommodation device. If a relevant closure body is present, typically the election will be made to dispose the corresponding buoyant body above the closure body, so that water which rises in the “accommodation chamber” will reach a bouyant body associated with the housing only when the closure body is in the closed position. The term “buoyant body” should be understood to mean a body which floats on the surface of water and does not sink. It is possible to dispose separate floats on the housing, or to design the housing with floats already integrated into it. This may be implemented structurally, for example, by providing the housing with walls which have at least one hollow space. The hollow space may be filled with, e.g., air. Alternatively or additionally, a housing wall may be fabricated from a low-density material, which then floats on the water surface based on the difference in the densities, and does not sink. Such a material may comprise, e.g., plastic, in particular a foamed plastic. With this arrangement, upward movement of the housing would be induced by a rise in the water level in the accommodation space. Conversely, downward movement of the housing would be induced by a decreasing water level in the accommodation space. Self-evidently, it is possible to bring about controlled movements of the housing by employing suitable drive means; these movements may be carried out independently by such drive means or in combination [with the influence of the buoyant body].

In this connection, it is also conceivable to suspend the holding device (in particular the associated housing), in the manner of a hanging lamp or chandelier, in the “accommodation chamber” associated with the accommodation device, with the suspension being from a wall bordering the “accommodation chamber”. In this case a suitable hanging fixture may be provided, by means of which the holding device can be hung on a wall bordering the “accommodation chamber”, in particular a wall which is oriented or extends horizontally.

Apart from the basic possibility of providing the holding device with means whereby it is freely movably guided in the “accommodation chamber” associated with the accommodation device, the subject Component, particularly the accommodation device, may be associated with at least one drive means which is/are coupled or couplable to the holding device, which drive means can cause movement of the holding device which is accommodated in the “accommodation chamber”. Thus movements of the holding device may be induced by a drive device which is coupled or couplable to the holding device. The drive device may be comprised of a control unit which is designed to generate control information for controlling the operation of the drive device. The drive device may be advantageously employed to move the holding device into a position which is more easily accessible by an operator. The drive device may be actuated, e.g. automatically, if the amount of the bait in the holding device is below a minimum amount (namely a minimum weight and/or minimum volume, e.g. as determined by an appropriate sensor system) and the bait ought to be replaced. Further, the drive device may be actuated, e.g. automatically, if the charging state of an energy storage device provided (and disposed) in association with the holding device, particularly in association with the “accommodation chamber” (or the receptacle chamber), reaches (falls below) a certain level (e.g. as determined by a suitable “detection device”), and the energy storage device ought to be replaced.

The drive device may be in the form of, or may at least be comprised of, a motor-driven drive means, e.g. in the form of an electric motor. At least one motor-driven drive means may be provided, which is coupled to or is couplable to the holding device and is designed to cause movement of the holding device based on a driving force produced by means of said drive means. The coupling between the motor-driven drive means and the holding device may be implemented by means of at least one tensile-type force-transmission means, e.g. in the form of a tensile belt or tensile chain.

Alternatively or in addition, the (or a) drive means may be in the form of, or may at least be comprised of, a magnetic drive means. At least one magnetic drive device may be provided, which is coupled to or is couplable to the holding device and is designed to cause movement of the holding device based on a magnetically generated driving force. The magnetic drive device typically comprises at least one magnetizable and/or magnetic magnet element associated with the accommodation device and another such magnet element associated with the holding device. The magnet elements, one associated with the accommodation device and one with the holding device, mutually interact magnetically, whereby a magnetic force of attraction sufficient to move the holding device in the accommodation space may be generated. Electromagnetic magnet elements as well as permanent-magnet magnet elements may be considered. A “magnetizable magnet element” may comprise, e.g., an electromagnet, which when a current is applied generates a magnetic force of attraction; a “magnetic magnet element” may comprise, e.g., a permanent magnet, which has a static magnetic field and continuously generates a magnetic force of attraction.

In this context, different configurations are conceivable. It is possible to provide at least one electromagnetic magnet element which can be energized when needed, in association with the accommodation device, and to provide a permanent magnet element in association with the holding device wherein when the electromagnetic element is subjected to a current it interacts with the permanent magnet magnetic element, whereby the holding device is caused to move as a result of the magnetic attraction. Conversely, it is possible in principle to provide at least one electromagnetic magnet element in association with the holding device and at least one permanent magnet element in association with the accommodation device. Similarly, electromagnetic magnet elements may be provided in association with both the accommodation device and the holding device; or permanent magnet elements may be provided in association with both the accommodation device and the holding device.

Individual magnet elements associated with the accommodation device and with the holding device may be disposed so that, at least in regions, they are exposed on surfaces of the accommodation device and of the holding device, respectively; or such magnet elements may be disposed interiorly of (integrated into) the accommodation device and the holding device, respectively, where they are not exposed [on such surfaces]. It is also possible for the accommodation device and/or the holding device to be comprised of a magnetic or magnetizable material, such as e.g. ferritic steel, or of a material which has a filling comprising magnetic or magnetizable particles, which material may comprise, e.g., plastic; such compositions may be present over the entire extent of said device(s) or only in certain regions of it/them.

Finally, it is possible that at least one signal transmission device may be provided, possibly as part of an associated transmitting and/or receiving system, which may be structurally integrated into or disposed in the Component Body. The signal transmission device is designed to transmit communication signals to at least one external communication device (external in that it is disposed at a location which is spatially separated from the subject Component), and/or to receive communication signals from at least one external communication device. For this purpose, the signal transmission device is comprised of at least one signal transmission element, which in turn is comprised of at least one antenna element, which is comprised of e.g. a metallic conductor element, which extends through the Component Body in at least some regions of the latter. It is possible to utilize a plurality of signal transmission elements in apt arrangements and orientations, e.g. planar arrangements, in order to obtain specific transmission and/or reception characteristics of the signal transmission device. Also, the signal transmission device may be designed to increase the signal strengths of communication signals of interest.

The manner in which the transmission device is structurally integrated into or disposed in the Component is essentially (physical) structural integration or disposition in the interior of the Component and/or of the Component Body. In this connection, the signal transmission device is embedded in a wall of the Component Body, with the material of which the Component Body is formed surrounding the signal transmission device, typically in immediate proximity. The signal transmission device can be structurally integrated into the Component.by, e.g., a casting process involving a signal transmission element and a material of which the Component is formed. Also, recesses may be provided in the Component, in and through which at least one signal transmission element may be disposed. It is conceivable for the signal transmission device to project outwardly from the Component Body, in certain regions, typically in regions of free ends of the signal transmission device. Thereby the signal transmission device can be coupled to another signal transmission device and/or to a transmitting and/or receiving device.

The communication signals to be transmitted by the signal transmission device may comprise, e.g., signals from detection devices (sensors and the like) associated with the Component or in particular the holding device. Such a structurally integrated signal transmission device is particularly advantageous in circumstances where it is difficult to transmit the desired communication signals from the Component 1 (e.g. which may be installed underground) to an external communication device. The signal transmission device can be employed to transmit (e.g. pass) desired communication signals from a signal source which is installed, e.g., underground, such as a sending device which is associated with a “detection device” which in turn is associated with the holding device, namely to pass them through the Component, and further to transmit them to an external communication device.

The invention further relates to an object, movable or immovable, which is comprised of at least one Component of a type which is described herein. A “movable object” may comprise, e.g., a movably mounted container, which may be movable by suitable means, e.g. wheels, rollers, or rail-like means, and is intended to contain, e.g., wastes, materials which are to be spread [over a ground surface], etc.; another example of a movable object is a vehicle or other means of transport, e.g. a railroad train or a ship. An immovable object may comprise, e.g., a structure [(as defined above)]. A “structure” in the present context may comprise a structural object associated with an above-ground [and/]or below-ground structure. Examples of “structures” are: bridges, frames, scaffolding, channels (especially in a system for disposal of sewerage and/or wastewater and/or runoff water), conduits, shafts, and manholes (especially conduits or shafts or manholes in a system for disposal of sewerage and/or wastewater and/or runoff water), staircases, tunnels, masonry, poles, piles, posts, columns, pylons, support means, towers, supply panels [(e.g. for utilities such as electricity, gas, and water)], walls, etc.

All of the embodiments [disclosed] in connection with the described Component apply analogously for a movable or immovable object.

Further advantages, features, and details of the invention will be apparent from the exemplary embodiments illustrated in the Figures.

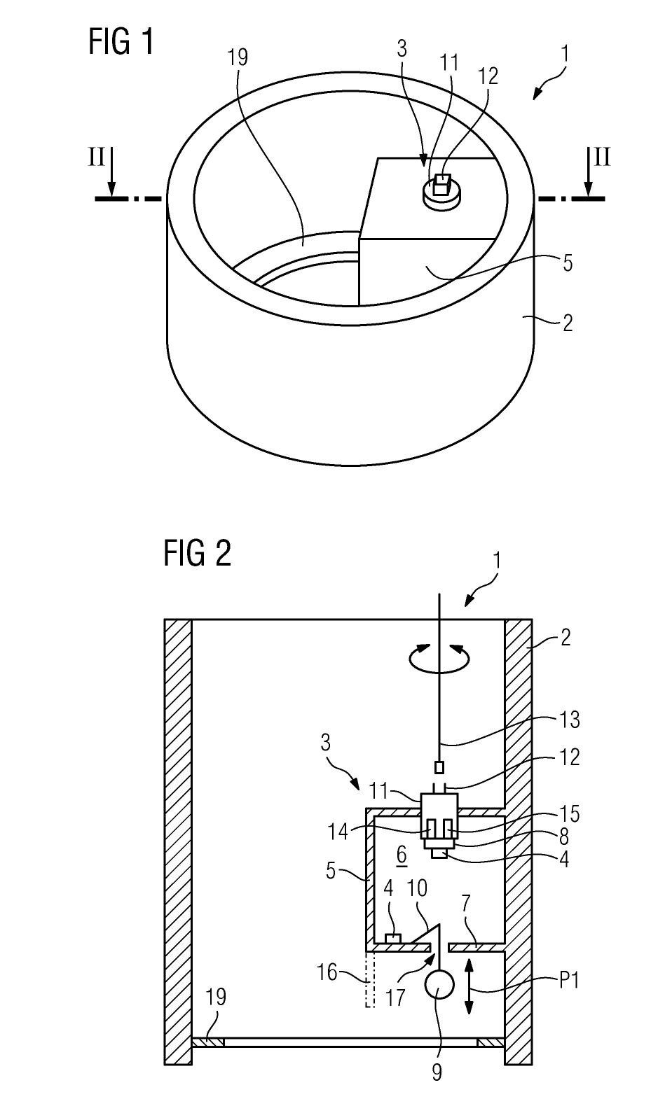

FIGS. 1 to 18 each show a schematic diagram of a Component according to an exemplary embodiment.

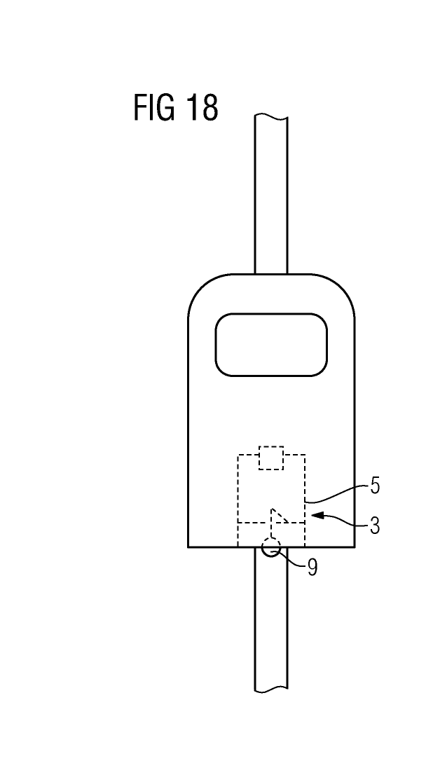

FIGS. 1 to 16 illustrate exemplary embodiments of a Component 1 for an immovable object. All of the embodiments [disclosed] in connection with the exemplary embodiments illustrated in FIGS. 1 to 16 apply analogously for Components 1 for a movable object, e.g. such as illustrated in FIGS. 17 and 18.

FIGS. 1 and 2 show a schematic representation of a Component 1 according to a first exemplary embodiment, in a perspective view (FIG. 1) and in a cross sectional view along the line II-II in FIG. 1 (FIG. 2).

The Component 1 is a component for forming an immovable object in the form of a “structure” (described below), or a part thereof. The term “structure” is understood to mean a channel or a shaft, e.g. comprising part of a shaft system, or a system for disposal of sewerage and/or wastewater and/or runoff water, or a manhole or manhole system. Thus, the Component 1 is a channel element or shaft element.

The Component 1 is comprised of a Component Body 2. The Component Body 2 is comprised of a material of construction, particularly concrete, and the basic geometric shape of it is (essentially) that of a hollow cylinder. Other materials of which the Component Body 2 might be comprised are plastics, particularly extrudable or injection-moldable plastic materials, e.g. a polyolefin such as PA, PC, PE, PP, or PS, and in particular thermoplastic materials.

The Component 1 is further comprised of a holding device 3 for holding a bait 4. The holding device 3 comprises a housing 5. The housing 5 delimits a receptacle chamber 6 for receiving a bait 4, and comprises a platform 7, which may be designated as and considered as a bait platform. The platform 7 delimits a pass-through opening (not described in detail) through which a pest can access a bait 4 arranged in the housing 5. Thus, the pass-through opening provides a means of direct access into the receptacle chamber 6 in the housing. The pass-through opening thus defines an upper region (of the housing 5) above said pass-through opening, and a lower region (of the housing 5) below said pass-through opening. As seen, the bait 4 is arranged in the upper region, which in the embodiment shown forms the receptacle chamber 6 which is bounded by the housing. It is readily seen from FIG. 2 that the bait 4 can be arranged on the platform 7. Other possibilities for disposition of the same or other baits 4 are shown in dashed lines. Thus, the same or other baits 4 may be arranged on and supported by (or from) a mounting device 8.

The device 3 is integrated into the Component 1. This is realized in that a part of the holding device 3, i.e. a part of the housing 5 and a part of the platform 7, is formed by a part of the Component Body 2 and thus is physically integrated into the Component Body 2. It is readily seen that a wall region of the Component Body 2 also forms a wall region of a wall of the housing 5, in relation to the holding device. The holding device 3 is thus integral to and of unit construction with the Component Body 2. The holding device 3, thus the housing 5, extends over regions of the interior perimeter of the Component Body 2, having an effect on (or determining or forming) the outer geometric shape of the Component 1.

Concerning the problem of possible contamination of the environment around Component 1 by means of poisons or active substances contained in the bait 4, the holding device 3 is designed such that the region of the housing 5 in which the bait 4 is arranged can be hermetically sealed, such that penetration of water, at least into this region of the housing 5, is not possible.

In general, the holding device 3 is designed so that, in the event of inflow or rising of water into or in the housing 5, the given volume (internal volume) and the sealing of the housing 5 give rise to development of a physical back-pressure in the housing 5, which opposes and counteracts the said inflow or rising of water. This is due to the fact that the air in the housing 5 is compressed by the inflow and the rising of water. The rising of water in the housing 5 thus becomes increasingly difficult due to the counterpressure which develops.

The holding device 3 is further provided with a closure body 9. As indicated by the double arrow P1 in FIG. 2, the closure body 9 is disposed so as to be movable relative to the platform 7, between an open position and a closed position. In the open position, the closure body is moved away from the platform 7 in such a way that the pass-through opening, which is delimited by the platform, is essentially open. Accordingly, when the closure body 9 is in its open position, a pest can negotiate the pass-through opening and can pass into and out of the upper region of the housing 5. In the closed position shown by dashed lines, the closure body 9 is moved toward the platform 7 in such a way that the pass-through opening, which is delimited by the platform, becomes closed. Accordingly, when the closure body 9 is in its closed position, a pest cannot negotiate the pass-through opening in order to pass into or out of the upper region of the housing 5. When the closure body 9 is in its closed position, it closes off and hermetically seals off the pass-through opening 8, so that penetration of water into the upper region of the housing 5, e.g. due to splashes or surges of water or flooding, is not possible. Consequently, in this way, means have been provided which tend to remedy the general problem of contamination of the surroundings around the Component 1 arising from substances of which the bait 4 is comprised.

To realize the movable mounting of the closure body 9, the closure body 9 is fastened to a holding element 10 mounted pivotably on the platform 7, which holding element has a clamping or clip-like action. The holding element 10 is affixed to the platform 7 on one side, and to the closure body 9 on the other side. The path of movement which the closure body 9 executes in moving from the open position into the closed position, and in return, is defined by: the location of the connection of the closure body 9 to the holding element 10, the location of the connection of the holding element 10 to the platform 7, and the geometric dimensions, in particular the shape, of the holding element 10.

The closure body 9 is in the form of a buoyant body. This is achieved in that the closure body 9 is designed to have a hollow space (not shown) filled with air. A movement of the closure body 9 from the open position into the closed position is thus induced automatically by a rise in the water level in Component 1. Correspondingly, a movement of the closure body 9 from the closed position into the open position is induced by a drop in the water level in Component 1.

To facilitate the access of a pest to the platform 7 via the closure body 9, the closure body 9 may inhibit or prevent slippage of a pest (i.e. improve the traction of a pest) which is engaging the closure body 9, by means of at least one region having a feature comprising surface structuring and/or (possibly adhesive) surface coating and/or surface overlayering (which features are not shown). In the case of a cup-shaped and/or spherical-segment-shaped closure body 9, a suitable surface structuring and/or surface coating and/or surface overlayering may be disposed or formed in at least some parts of a circular region on the surface of the closure body 9.

An accommodation chamber 11, which accommodates electrical and/or electrical components of the holding device 3, is attached to the housing 5. The accommodation chamber 11 offers protection for these components with respect to external influences, in particular climatic and mechanical influences. The accommodation chamber 11 is realized in the form of a separate component from the housing 5, which is individually attached to the housing 5. Removal of the accommodation chamber 11 from the housing 5 provides access to the receptacle chamber 6.

The accommodation chamber 11 is attached to the housing 5 in a manner such that it can be removed without damage. The means by which the accommodation chamber 11 is attached to the housing 5 involve attachment region(s} on or associated with the housing 5 (not shown) which cooperate(s) with cooperating attachment regions(s) on or associated with the accommodation chamber 11 (also not shown). The accommodation chamber 11 is rotatably mounted on the housing 5, so as to be rotatable between a fastened position and a release position. In the fastened position, the attachment region(s} on or associated with the housing and the attachment regions(s) on or associated with the accommodation chamber interact in such a way that the accommodation chamber 11 is connected to the housing 5 in a stable manner. In the release position, the attachment region(s) on or associated with the housing and the attachment regions(s) on or associated with the accommodation chamber do not interact, and consequently the accommodation chamber 11 is removable from the housing 5. The accommodation chamber 11 can thus be converted from the fastened position to the release position and vice versa by rotational movements relative to the housing 5. The accommodation chamber 11 may attached to and released from the housing 5 by appropriate rotational movements of the accommodation chamber 11 relative to the housing 5.

To bring about appropriate rotational movements of the accommodation chamber 11, the accommodation chamber 11 is provided with at least one tool-engagement region 12 for shape-interlocking engagement of a tool 13 in the region of an upper exposed cover area, rotational movements being transferable to the accommodation chamber 11 by means of said tool to convert the accommodation chamber 11 from the fastened position to the release position and vice versa. Due to the configuration and/or design of the tool-engagement region 12 in the region of an upper exposed cover area on the cover of the accommodation chamber 11, the accommodation chamber is always accessible (from above).

Through suitable shaping and dimensioning of a corresponding tool 13, it is not absolutely necessary for a user to have physical access to the Component 1, e.g. [in the case that the Component Body 2 comprises a manhole,] to be able to descend into the manhole, in order to convert the accommodation chamber 11 from the fastened position into the release position or vice versa by means of corresponding rotational movements. Thus, the accommodation chamber 11 can be detached from outside the channel or shaft of the housing 5 which encompasses or comprises Component 1 [(i.e. can be detached by an operator working from a position located outside the channel)], and if desired the accommodation chamber 11 can be removed from said channel or shaft. If the bait 4 is held via the bait-mounting device 8 disposed on the accommodation chamber 11, the accommodation chamber 11 together with the bait-mounting device 8 and the bait 4 held thereon can be removed from the channel or shaft without the operator entering said channel or shaft, and it is possible to detect whether a bite has been applied to the bait and, if necessary, to exchange or replace a bait 4 (or the bait 4) and then to re-introduce the bait into the channel or shaft. This may be done, e.g., for purposes of inspection, e.g. to ascertain whether there has been a bite on the bait; and thereby inspections may be performed in a practicable, substantially simplified, and substantially more rapid manner.

A monitoring device 14, in the form of, or comprising, an infrared or CCD camera, is disposed in the accommodation chamber 11, for monitoring at least a portion of the receptacle chamber 6 which is delimited by the housing. The monitoring device 14 is disposed such that the receptacle chamber 6 can be monitored over a very wide range. The monitoring data supplied by the monitoring device 14 can be sent to an external communication device (not shown), via a modular transmitting and receiving device 15 which is likewise disposed in the accommodation chamber 11, by a radio-like mode, e.g. Bluetooth, DECT, WLAN, etc. The monitoring device 14 is supplied with electrical energy via a rechargeable electrical energy storage system, e.g. a rechargeable battery (not shown), which is also disposed in the accommodation chamber 11. The monitoring device 14, the transmitting and receiving device, and the electrical energy storage system are each electrical or electronic components of the holding device 3.

Using the monitoring device 14, it is possible to monitor all of the processes occurring in the receptacle chamber 6. In particular processes related to pests can be detected and determined qualitatively and/or quantitatively, and can be further evaluated. Processes of particular interest to be monitored quantitatively and/or qualitatively include, e.g., entrance by pests into the receptacle chamber 6, egress by pests out of the receptacle chamber 6, the behavior, i.e., in particular biting and/or movement behavior, of the pests which enter the receptacle chamber 6, while they are in said chamber, etc. In general, the number of pests entering (“the pests frequenting”) the receptacle chamber 6 per unit of time can be determined, on a qualitative and/or quantitative basis, and can be subjected to evaluations. Since monitoring data acquired by the monitoring device 14 can be transmitted to an external terminal accessible to a user, e.g. a cellphone, smart phone, tablet computer, notebook computer, or other portable electronic device, the monitoring device 14 can serve for monitoring of all activities and processes in the receptacle chamber 6 without a need for physical access to the Component 1.

A surge protection element 16 may be provided which is disposed or formed on the housing 5, for protection against penetration of water into the receptacle chamber 6 delimited by the housing (or by elements associated with the housing), in the event that the water level rises suddenly (water surges) or is present due to splashing; this protection element 16 is shown in dashed lines to indicate that it is optional. The surge protection element 16 is disposed below the platform 7. The surge protection element 16 may be realized such that it is integral with the Component Body 2.

As mentioned, regarding the exemplary embodiment illustrated in FIGS. 1 and 2, direct access to the receptacle chamber 6 associated with the housing is provided, namely through the pass-through opening delimited by the platform. In particular, the pass-through opening is in the form of an access opening 17 to the receptacle chamber 6.

Further, an access platform 19 is provided which is associated with the Component Body, in order to facilitate access to the access opening 17; this platform 19 is shown in dashed lines, to indicate that it is optional. Depending on the disposition and orientation of the access opening 17, the access platform 19 can be configured as a ramp, or a helical incline, or a helical staircase, which ascends (or descends) along the Component Body 2.

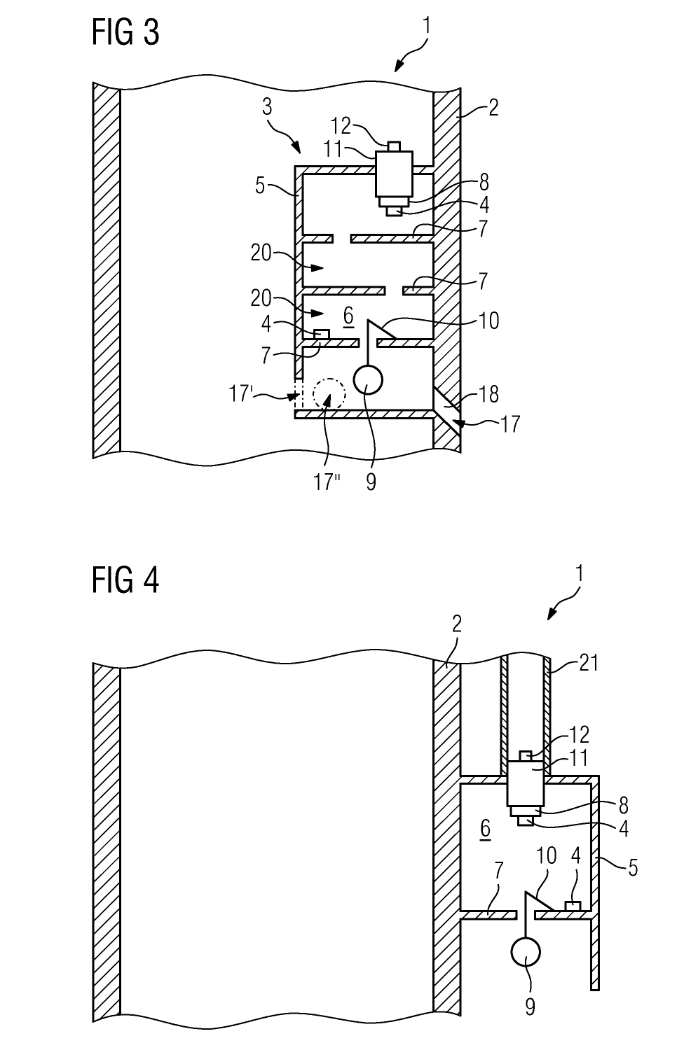

FIG. 3 shows a schematic diagram of a Component 1 according to a second exemplary embodiment, in a cross sectional view analogous to FIG. 2. In contrast to the exemplary embodiment illustrated in FIGS. 1 and 2, in the exemplary embodiment according to FIG. 3 an access opening 17 is formed in a wall of the Component Body 2. The access opening 17 communicates with an access channel 18 extending through the wall of the Component Body 2; thus, the access opening 17 provides indirect means of access to the receptacle chamber 6 delimited by the housing. In the exemplary embodiment according to FIG. 3, the access channel 18 extends at an upward (or downward) angle through the wall of the Component Body 2.

Possible alternative or additional access openings (17′, 17″) are illustrated in dashed lines in FIG. 3. E.g. it is possible to provide an access opening 17 in a wall (or a plurality of walls) of the housing 5 which does not extend through a wall of the Component Body 2 itself. The access openings 17 may be oriented parallel to or at angles to an available surface of the Component Body 2. As specific examples, in FIG. 3 an access opening 17′ is oriented in a radial direction and another access opening 17″ is oriented in a circumferential direction (in both instances, as to the hollow cylindrical geometry of the Component Body 1). It may be advantageous to have a circumferentially oriented access opening 17″ in the case of a Component 1 which comes into contact with water, because this hinders or prevents entry of water into the holding device 3, in the event that water tends to be present at that level due to splashing or surging.

FIG. 3 also illustrates the possible of providing a plurality of platforms 7 in the housing 5. An intermediate space 20 defining an intermediate level is formed between two platforms 7 disposed near each other in the succession. Individual intermediate spaces 20 communicate with each other via respective pass-through openings delimited by the platforms; thus a possibility is provided of passage through all of the platforms 7. Depending on the geometric configurations and dispositions of the platforms 7, a plurality of platforms may be parallelly oriented, at least in part. Although this feature is not shown, in principle each platform 7 may have its own closure body 9 associated with it. The above-described principle of using a closure body 9 to hermetically seal a pass-through opening delimited by the platform, wherewith the closure body 9 is moved into a corresponding closed position, is also applicable here.

FIG. 4 shows a schematic diagram of a Component 1 according to another exemplary embodiment, in a cross sectional view analogous to FIG. 2. In contrast to the exemplary embodiments illustrated in the above-described Figures, the housing 5 here extends outwardly outside of part of the outer circumference of the Component Body 2. In order to provide a means of access to the accommodation chamber 11, which is now disposed outside of the interior space defined by the Component Body 2, an access element 21 is provided which optionally is structurally connected to the Component Body 2 and/or the housing 5. The access element 21 may be in the form of a tube or a (flexible) hose.

FIG. 5 shows a schematic diagram of a Component 1 according to still another exemplary embodiment, in a cross sectional view analogous to FIG. 2. The housing 5 here is structurally completely integrated into the component body 2, so that, in contrast to the exemplary embodiments illustrated in the above-described Figures, it does not extend beyond the outer circumference of the Component Body 2. In order to provide a means of access to the receptacle chamber 6 delimited by the housing, an access opening 17 is provided in the wall of the Component Body 2. In order to provide a means of access to the interior of the accommodation chamber 11, which is disposed inside the Component Body 2, an access element 21 is provided which optionally is structurally connected to the Component Body 2 and/or the housing 5. The access element 21 may be in the form of a hole, e.g. a drilled hole. A tube, pipe, or hose may be accommodated in the said hole.

In connection with the exemplary embodiment illustrated in FIG. 5, purely by way of example, and not limited to this embodiment but in principle also applicable in supplementation of the other exemplary embodiments, it is possible to provide a signal transmission device (not described in more detail), possibly as part of a transmitting and/or receiving system (not shown), which may be structurally integrated into or disposed in the Component Body 2. The signal transmission device is designed for transmitting communication signals to an external communication device (not shown) and/or for receiving communication signals from at least one external communication device, and for this purpose comprises at least one signal transmission element (not shown). The signal transmission element is comprised of an antenna element, which is comprised of e.g. a metallic conductor element, which extends at least partly through the Component Body 2. The communication signals to be transmitted by the signal transmission device may comprise, e.g., signals from detection devices (sensors and the like) associated with the Component or in particular the holding device.

The manner in which the transmission device is structurally integrated into or disposed in the Component 1 is essentially structural integration or disposition in the interior of the Component 1 or the Component Body 2. In this connection, the signal transmission device is embedded in a wall of the Component Body 2, with the material of which the Component Body 2 is formed surrounding the signal transmission device.

Such a structurally integrated signal transmission device is particularly advantageous in circumstances where it is difficult to transmit the desired communication signals from the Component 1 (e.g. which may be installed underground) to an external communication device. The signal transmission device can be employed to transmit (e.g. pass) desired communication signals from a signal source which is installed, e.g., underground, such as a sending device which is associated with a “detection device” which in turn is associated with the holding device, namely to pass them through the Component 1, and further to transmit them to an external communication device.

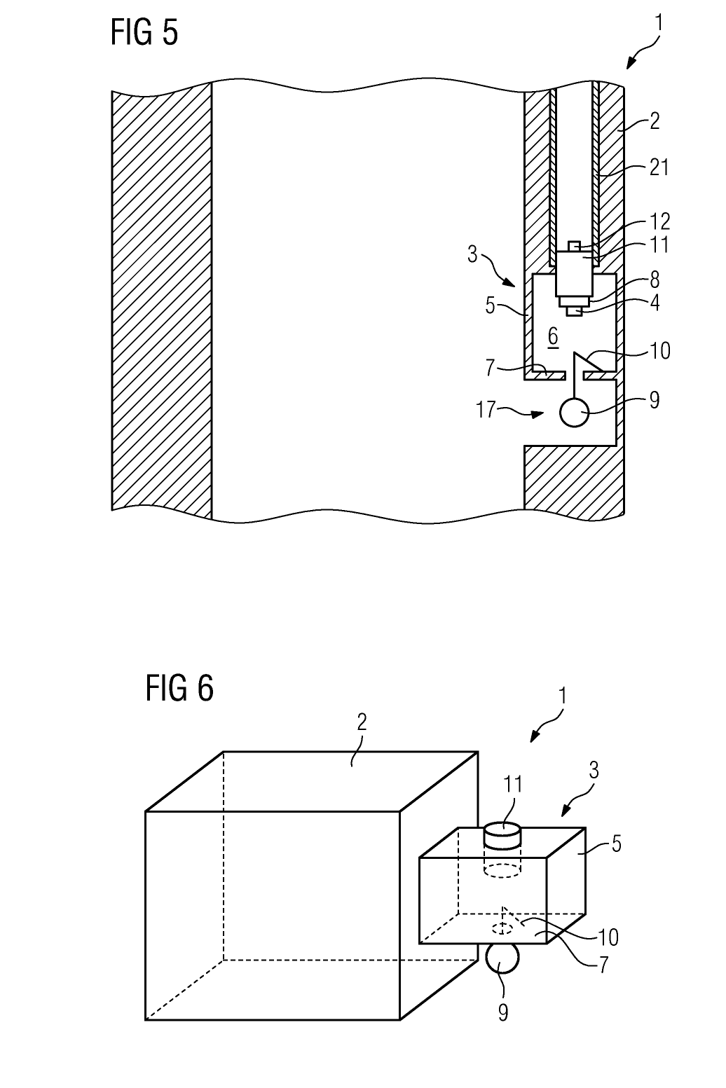

FIG. 6 shows a schematic diagram of a Component 1 according to yet another exemplary embodiment, in a perspective view. In contrast to the exemplary embodiments shown in the above-described Figures, the shape of the Component Body 2 here is not a hollow cylindrical shape but a shape with a generally quadrilateral (in particular rectangular or square) cross section. The Component 1 may comprise, e.g., a precast concrete element. It is seen that a part of the holding device 3 or of the associated housing 5, formed by a region of the Component Body 2, is disposed on an outer surface of the Component Body 2. When the housing 5 is installed in a particular installation, e.g. in a particular structure, the outer surface [of the aggregate] is typically visible; the same is true of the [outer] part of the housing 5 which is disposed on the structure. The part of the housing 5 which is disposed on the outer surface of the Component Body 2 extends outward from said Component Body 2.

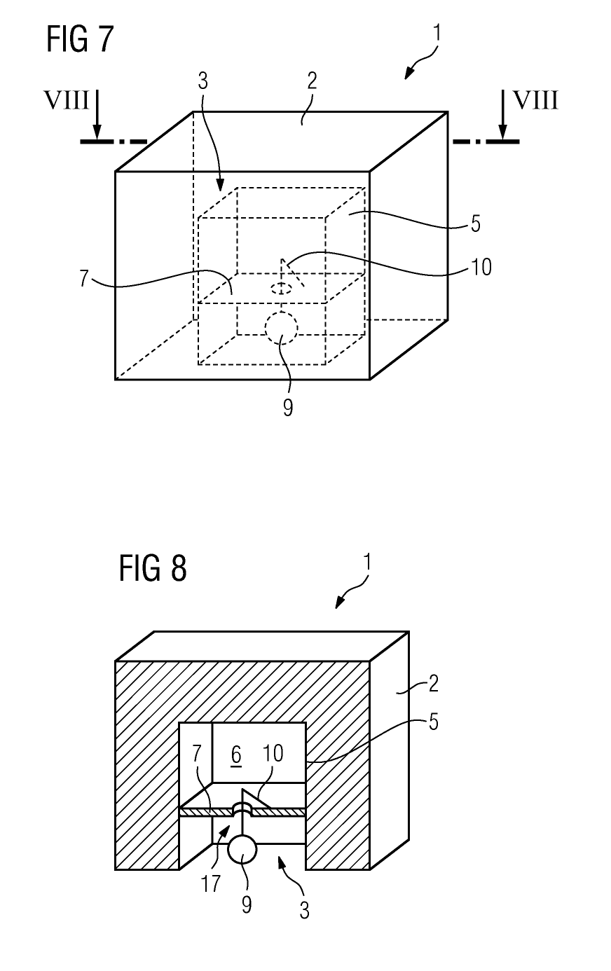

FIGS. 7 and 8 show a schematic representation of a Component 1 according to another exemplary embodiment, in a perspective view (FIG. 7) and in a cross sectional view along the line VIII-VIII in FIG. 7 (FIG. 8). In contrast to the exemplary embodiment illustrated in FIG. 6, the part[s] of the holding device 3 formed by portions of the component body 2 are comprised of an inner surface of the Component Body 2 delimiting a hollow space in said component body 2. The hollow space also forms the receptacle chamber 6 delimited by the housing or by elements associated with the housing, and when the Component 1 is installed in, e.g. a structure, it [(said housing 5)] is not visible; the same applies to the parts of the holding device 3 formed thereon [(on said housing 5)]. Based on the disposition and orientation of the access opening 17, it can be seen that possible access to the receptacle chamber 6 delimited by the housing (or by elements associated with the housing) is available from below.

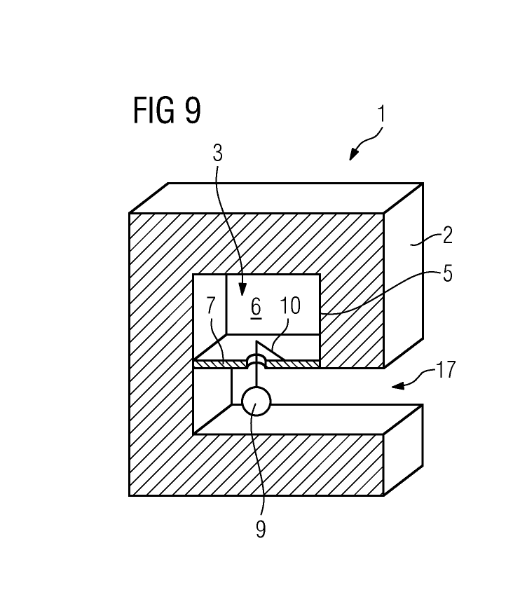

FIG. 9 shows a schematic diagram of a Component 1 according to still another exemplary embodiment, in a perspective view. Based on the disposition and orientation of the access opening 17, it can be seen that, in contrast to the exemplary embodiment illustrated in FIGS. 7 and 8, access to the receptacle chamber 6 delimited by the housing (or by elements associated with the housing) is available from the side.

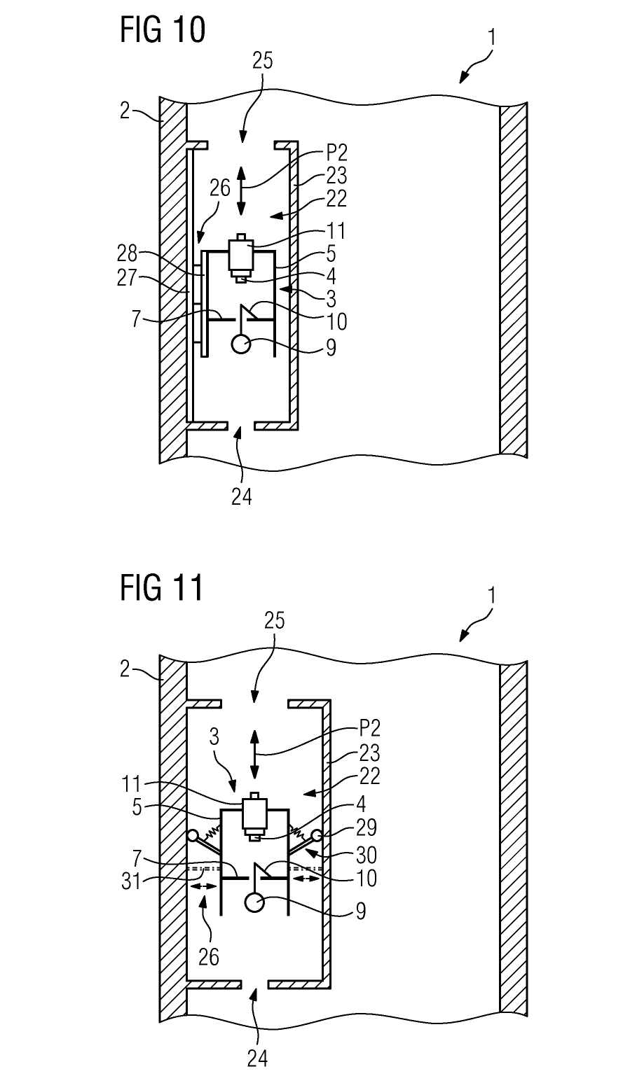

FIG. 10 shows a schematic diagram of a Component 1 according to yet another exemplary embodiment, in a cross sectional view analogous to FIG. 2. In contrast to the exemplary embodiments illustrated in the above-described Figures, an accommodation device 23 is integrated into the Component 1. This is realized in that a part of the accommodation device 23 is formed by a part of the Component Body 2 and thus is physically integrated into the Component Body 2. It is readily seen that a wall region of the Component Body 2 also forms a wall region of a wall of the accommodation device 23. The accommodation device 23 is thus integral to and of unit construction with the Component Body 2. The accommodation device 23 extends over regions of the interior perimeter of the Component Body 2, and has an effect on (or determines or forms) the outer geometric shape of the Component 1.

The accommodation device 23 is designed for accommodating the holding device 3, and for this purpose it delimits an accommodation space 22 having a channel configuration or tubular configuration. The accommodation device 23 has a first access opening 24, through which a pest can penetrate into the associated accommodation space 22 and thence into the housing 5 of the holding device 3 disposed in the accommodation space 22 and into the receptacle chamber 6 delimited by the housing or by elements associated with the housing.

The accommodation device 23 has a second access opening 25, through which the holding device 3 can be inserted into or removed from its associated accommodation space 22. The access openings 24 and 25 are disposed in different regions of, in particular on opposite ends of, the accommodation device 23. The second access opening 25 can be provided with a movably mounted closure element (not shown), e.g. a swingable closure element, which can be moved between an open position, allowing the holding device(s) 3 to be inserted into or removed from the accommodation space 22, via said second access opening 25, and a closed position, preventing the holding device(s) 3 from being inserted into or removed from the accommodation space 22.

The accommodation device 23 is comprised of guide means 26 designed to guide the holding device 3 in movement within the accommodation space 22, relative to the Component Body 2, as indicated by the arrow P2. Thereby the holding device 3 can be guided in movement relative to the Component Body 2. Movements of the holding device 3 occur along a vertically oriented linear axis of movement. For this purpose, the guide means 26 are provided with suitable guiding elements 27, e.g. guide grooves or projections (such as a guide boss or guide ridge), which cooperate with suitable partner guiding elements 28, e.g. correspondingly configured guiding projections or grooves, on or associated with the holding device 3, in particular on or associated with the housing 5, forming means of guiding the holding device 3 in linear movement inside the accommodation space 22.

In the exemplary embodiment according to FIG. 11, guide means 26 are shown which comprise a plurality of wheel-type or roller-type guiding elements 29 disposed distributed on and/or around the housing 5 which is associated with the holding device 3; wherewith, by means of these rolling guiding elements, the housing 5 is (or can be) guided in movement along the wall of the accommodation device 23. Corresponding wheel-type or roller-type guiding elements 29 are in direct contact with the wall of the accommodation device 23, so that no special measures are necessary for guiding the holding device 3 in movement along the relevant walls. The wheel-type or roller-type guiding elements 29 are supported on a holding device 30 disposed on the housing 5. The wheel-type or roller-type guiding elements 29 are braced against the walls of the accommodation device 23 by means of the holding device 30. The holding device 3 can be reliably positioned in the desired vertical position(s) in the accommodation space 22 due to such holding and bracing. The stress is selected such that the holding device 3 is prevented from uncontrolled downward movement, while at the same time the holding device 3 can move upward under circumstances where such movement is desirable, e.g. in response to upward forces arising from water surges or water splashes.

A holding device 30 is also illustrated (dashed lines) [(i.e. a different holding device 30)] which is comprised of holding arms 31 which can be extended, in particular in telescopic fashion, in particular in a radial direction with respect to the axis of symmetry or central axis of the accommodation space 22, toward the walls of the accommodation device 23 (as indicated by the horizontal double arrow). Analogously to the description above, these holding arms 31 may be placed under urging stress by stressing elements (not shown), e.g. compression spring elements, which act against the walls of the accommodation device 23.

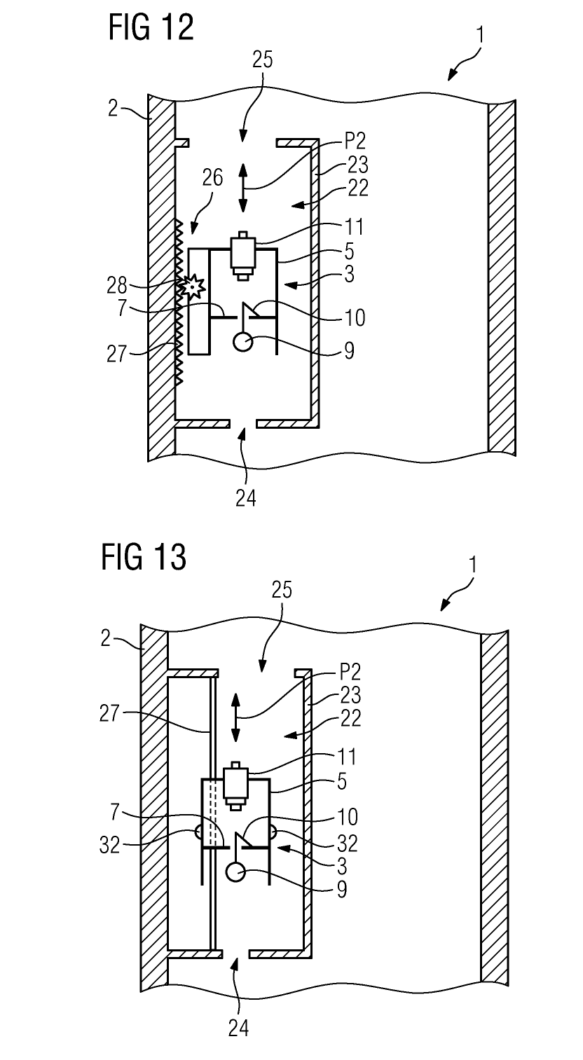

In the exemplary embodiment according to FIG. 12, a guiding device 26 is illustrated which is comprised of a gearwheel-type guiding element 27 associated with the holding device (particularly with the housing), and a corresponding toothed-rack-type guiding element 28 associated with the wall, which element 28 interacts with the element 27. By means of the guiding device 26, the holding device 3 is guided so that it is linearly movable on the wall of the accommodation device 3. In this case, the guiding device 26 thus also comprises guiding elements in the form of the guiding elements 27 associated with the wall. The matching guiding elements associated with the holding device and with the wall (27 and 28) interengage mechanically and cooperate to achieve linear movement of the holding device 33.

On the basis of the exemplary embodiment according to FIG. 13, it can be seen that a guiding device 26 may also comprise a profile-type or rod-type guiding element 27 fastened in the accommodation space 22 associated with the accommodation device and disposed on the holding device 3 and/or passing through the latter, in particular axially. The holding device 3 is guided here such that it is movable linearly relative to the profile-type or rod-type guiding element 27. The holding device 3 is attached to the profile-type or rod-type guiding element 27 which in turn is attached to the wall or to an element associated with the wall. Such a profile-type or rod-type guiding element 27 may also be advantageous in the exemplary embodiment according to FIG. 11.

The guiding device 26 may be comprised of at least one drive device, particularly a motor-driven drive device (not shown), e.g. an electric motor, which is coupled to or couplable to a guiding element 27, which drive device is designed to transmit a drive force to the guiding element 27 which drives the latter in a unidirectional or bidirectional driven movement. The drive device may be disposed on or in the housing 5 associated with the holding device. Alternatively or additionally, the drive device may also be disposed or formed on or in a suitable guiding element 27, e.g. the drive device may be integrated into or onto a suitable wheel-type or roller-type guiding element, or may be disposed in a gearwheel.

On the basis of the exemplary embodiment according to FIG. 13, it is also self-evident that buoyant means (floats) 32 may be provided, for causing or aiding in movements of the holding device 3 in the accommodation space 22. The buoyant means 32 are disposed above the closure body 9 on the holding device 3, in particular on the housing 5, so that water rising in the accommodation space 22 only reaches the buoyant means 32 associated with the holding device when the closure body 9 is already in the closed position. The buoyant means 32 illustrated in FIG. 13 are separate floats disposed on the housing 5. Alternatively or additionally, the housing 5 may have buoyant means 32 already integrated into (or on) it. This may be implemented structurally, for example, by providing the housing 5 with a wall which delimits or otherwise has at least one hollow space. In all cases, a rise in the water level in the accommodation space 22 will induce an upward movement of the holding device 3, and a decrease in the water level in the accommodation space 22 will induce a downward movement of the holding device 3.

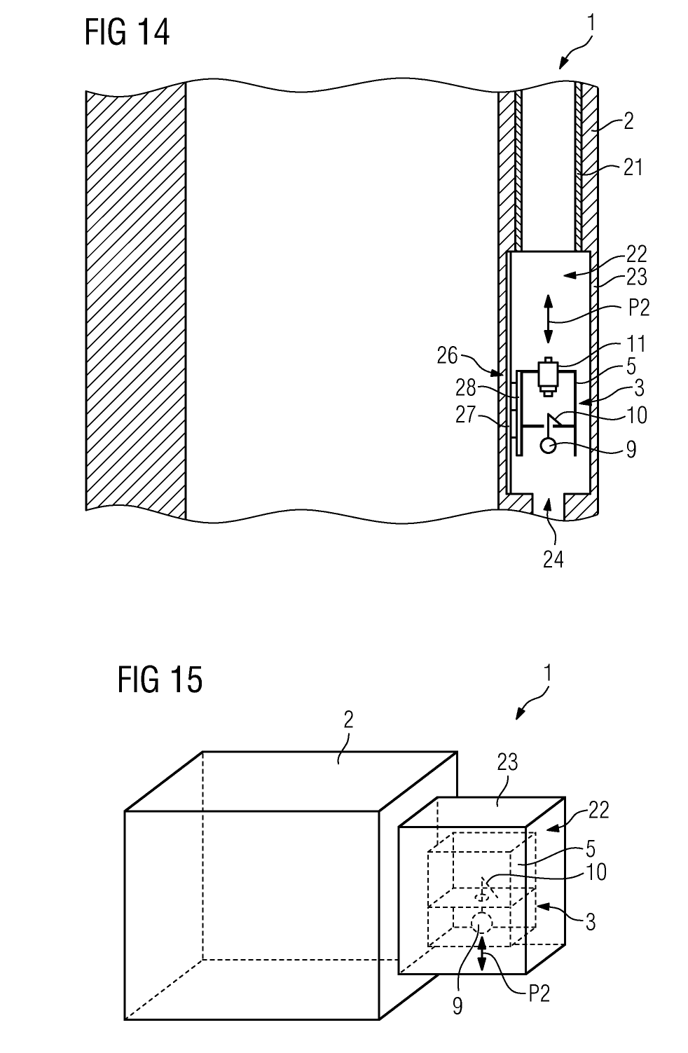

FIG. 14 shows a schematic diagram of a Component 1 according to another exemplary embodiment, in a cross sectional view analogous to FIG. 10. The accommodation space 23 here is structurally completely integrated into the component body 2, so that, in contrast to the exemplary embodiments illustrated in the above-described Figures, it does not extend beyond the outer circumference of the Component body 2. In order to provide a means of access to the interior of the accommodation chamber 22, which is disposed inside the Component body 2, an access element 21 is provided which optionally is structurally connected to the Component Body 2. The access element 21 may be in the form of a hole, e.g. a drilled hole. A tube, pipe, or hose may be accommodated in the said hole.

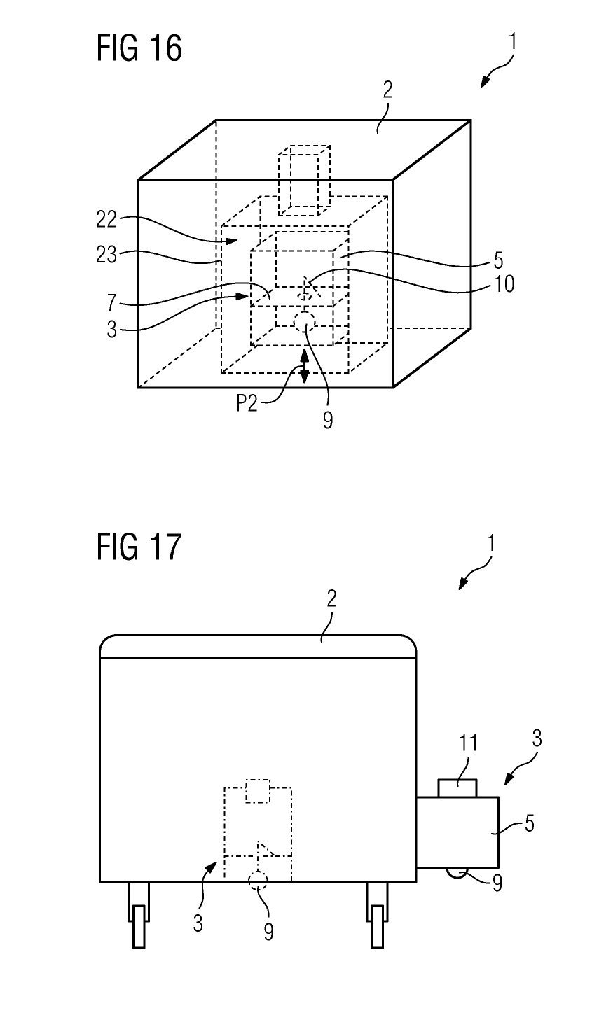

FIGS. 15 and 16 each show a schematic diagram of a Component 1 according to (in each instance) another exemplary embodiment, in a perspective view. In contrast to the exemplary embodiments shown in the above-described FIGS. 10-14, the shape of the Component Body 2 here is not a hollow cylindrical shape but a shape with a generally quadrilateral (in particular rectangular or square) cross section. The discussions of the exemplary embodiments illustrated in FIGS. 6 to 9 apply analogously here.

For the exemplary embodiments illustrated in FIGS. 10 to 16, apart from the possibility of the holding device 3 being guided freely movably within the accommodation space 22 associated with the accommodation device, the accommodation device 23 may be comprised of a drive device (not shown), e.g. in the form of an electric motor, which is coupled or couplable to the holding device 3 and by means of which the holding device which is disposed (accommodated) in the accommodation space 22 can be caused to move. The drive device may be comprised of a control unit (not shown) which is designed to generate control information for controlling the operation of the drive device.

FIG. 17 shows a schematic diagram of a Component 1 according to still another exemplary embodiment, in a front view (elevation view). The Component 1 forms part of a movable object, namely a container, e.g. for wastes, materials which are to be spread [over a ground surface], etc., which is equipped to be movable, e.g. via means such as wheels, rollers, or the like (not shown). The interior space of the container can be closed off by means of a cover element or flap element (which will not be described further here) which is disposed on the base body [, in particular the Component Body 2]. Here the Component 1 forms forms, e.g., the base body of the container, and the holding device 3 is disposed on a side wall of the base body of the Component 1. A variant in which the holding device 3 is disposed in the interior of the base body of the Component 1 such that it is not visible from the outside is also possible; this holding device 3 is shown in dashed lines.

FIG. 18 shows a schematic diagram of a Component 1 according to yet another exemplary embodiment, in a front view (elevation view). The Component 1 forms part or all of a basically movable object (movable because not fixedly attached to the ground or floor below), in particular a container for refuse or other wastes, which is attached, e.g., to a certain supporting structure in a public space, e.g. a mast, post, rod, or the like. The Component 1 forms part of the base body of the container. The holding device 3 is disposed in the region of the bottom of the container. Accordingly, the receptacle chamber 6 delimited by the housing or an element associated with the housing is accessible from below.

Features described in connection with embodiments illustrated in any of the Figures may be combined in any desired combination.

1. A Component (1), particularly for serving as a component of a movable or immovable object; comprised of:
a Component Body (2);
at least one holding device (3) for holding a bait (4) for pests, which holding device (3) is comprised of a housing (5) which delimits at least one receptacle chamber (6) for receiving at least one bait (4), wherein the housing (5) is comprised of at least one platform (7) which delimits at least one pass-through opening through which a pest can gain access to a bait (4) arranged in said housing (5);
wherein at least a part of the holding device (3), in particular at least one part of the housing (5), and/or at least one part of the at least one platform (7), and/or at least one part of an accommodation device (23) which device (23) delimits an accommodation space (22) for accommodating the holding device (3), is physically integrated with (“designed or formed integrally with”) at least one portion of the Component Body (2).

2. The Component according to claim 1; characterized in that
the at least one part of the holding device (3) and/or of the accommodation device (23) which is comprised of at least one portion of the Component Body (2) is comprised completely or at least partially of at least one wall of the Component Body (2); or
the at least one part of the holding device (3) and/or of the accommodation device (23) which is comprised of a portion of the Component Body (2) is disposed completely or at least partially in a wall of the Component Body (2).

3. The Component according to claim 2; characterized in that the Component Body (2) at least partially, in particular completely, has a hollow cylindrical basic geometric shape, wherein the at least one part of the holding device (3) and/or of the accommodation device (23) which is comprised of at least one portion of the Component Body (2) is disposed on the outer perimeter of the Component Body (2), or on the inner perimeter of the Component Body (2), or on an inner surface of the Component Body (2) which borders a hollow space within the Component Body (2).

4. The Component according to claim 2; characterized in that the Component Body (2), at least in one or more parts, and in particular completely, has the basic geometric shape of a quadrilateral parallelepiped, in particular a rectangular parallelepiped (or cuboid), wherein the at least one part of the holding device (3) and/or of the accommodation device (23) which is comprised of a portion of the Component Body (2) is disposed on an outer surface, particularly an end surface or lateral surface, of the Component Body (2), or on an inner surface of the Component Body (2) which borders a hollow space within the Component Body (2).

5. The Component according claim 1; characterized by at least one access opening (17) which provides a means of access to the receptacle chamber (6) which is delimited by the housing or by an element associated with the housing, which access opening (17) is disposed in a wall of the component body (2), or in a wall of the housing (5) which wall of the housing (5) is not formed by a wall of the Component Body (2).

6. The Component according to claim 5; characterized in that direct accessibility of the limited receptacle chamber (6) associated with the housing is provided through the access opening (17), or indirect accessibility of said receptacle chamber (6) is provided through the access opening (17) via at least one access channel (18) which communicates with said access opening (17).

7. The Component according to claim 5; characterized by an access platform (19), possibly having a ramp-like configuration, which provides access to at least one access opening (17), which platform (19) in particular may be disposed on or in the Component Body or on or in an element thereof.

8. The Component according to claim 1; characterized in that at least one accommodation space device (23) is provided, wherewith the accommodation device (23) is comprised of at least one guiding device (26) for guiding a holding device (3), in particular relative to the Component Body (2).

9. The Component according to claim 1; characterized in that a plurality of platforms (7) are disposed one above another in the housing (5), wherein an intermediate space (20) defining an intermediate level is formed between two neighboring platforms (7).

10. The Component according to claim 1; characterized by at least one closure body (9) which is movably mounted relative to the (or a) platform (7), which closure body (9) is movable away from the platform (7) into an open position such that the at least one pass-through opening associated with the platform is exposed; and said closure body (9) is movable against the platform (17) into a closed position such that the at least one pass-through opening associated with the platform is closed off.

11. The Component according to claim 10; characterized in that the closure body (9) is in the form of a buoyant body (e.g. a float), or is comprised of at least one buoyant body (float).

12. The Component according to claim 10; characterized in that the closure body (9) is mounted so as to be movable relative to the platform (7), by means of at least one movable, in particular swingable, holding element (10) which in particular may have a clamping action and which is mounted on or in the housing (5), in particular on the platform (7), or on or in another portion of the component (1), in particular of the Component Body (2).

13. The Component according to claim 1; characterized in that at least one accommodation chamber (11) is attached (or is attachable) to the housing (5) (on or in said housing), which accommodation chamber (11) accommodates electrical and/or electronic components of the holding device (3), and/or which accommodation chamber (11) has disposed on it or formed on it at least one bait-mounting device (8) for mounting a bait (4).

14. The Component according to claim 13; characterized in that at least one monitoring device (14), in particular optical, for monitoring at least part of the receptacle chamber (6) bounded by the housing (5), is disposed or formed on or in the accommodation chamber (11).

15. The Component according to claim 1; characterized by at least one surge protection element (16) for protecting against penetration of water into the receptacle chamber (6) bounded by the housing (5), in the event that the water level in a region around the holding device (3) rises due to splashing or surging, which surge protection element (16) is disposed or formed below the platform (7).

16. The Component according to claim 1; characterized in that at least one signal transmission device, in particular in the form of an antenna element, which is designed to transmit communication signals to at least one external communication device and/or to receive communication signals from at least one external communication device, is structurally integrated or formed, in the Component Body (2).

17. The Component according to claim 1; characterized in that said Component comprises: a delimiting element for delimiting a specific surface area or spatial region; or a bridge element or frame element for forming a frame or a channel, in particular a channel of a system for disposal of sewerage and/or wastewater and/or runoff water; or a manhole element for forming a manhole, in particular a manhole in a system for disposal of sewerage and/or wastewater and/or runoff water; or a tunnel element for forming a tunnel; or a wall element for forming a wall structure or other masonry structure; or a post element or pylon element or tower element for forming a post, pylon, or tower; or a step element for forming a staircase; or a wall element for forming a wall of a walled structure, in particular a building; or a support member for supporting a “third object”.

18. An immovable object (fixed object), particularly a structure (structural object) (i.e. an object in the subject area of structural engineering) which is formed according to claim 1; or an object which is comprised of such a structure.

19. A movable object, particularly a Component (1) according to claim 1; or an object which is comprised of such a Component.
